(19) United States
(12) Patent Application Publication
(10) Pub. No.: US 2026/0029599 A1
(43) Pub. Date: Jan. 29, 2026

(54) PACKAGING OF THIN FILM LITHIUM-CONTAINING PHOTONICS INTEGRATED CIRCUITS

(71) Applicant: HyperLight Corporation, Cambridge, MA (US)

(72) Inventors: Derek Matthew Kita, Somerville, MA (US); Fan Ye, Lincoln, MA (US); Christian Reimer, Wellesley, MA (US); Thomas Andrew Lobay, Somerville, MA (US); Jeffrey Cole Holzgrafe, Lexington, MA (US)

(21) Appl. No.: 19/283,066

(22) Filed: Jul. 28, 2025

Related U.S. Application Data
(60) Provisional application No. 63/676,741, filed on Jul. 29, 2024.

(51) Int. Cl. G02B 6/42; G02B 6/30

(52) U.S. Cl. CPC G02B 6/4293; G02B 6/30; G02B 6/4232; G02B 6/4249; G02B 6/4279

(57) ABSTRACT

A photonics package is described. The photonics package includes a thin film lithium-containing (TFLC) photonics integrated circuit (PIC), an additional integrated circuit, and an interposer. The TFLC PIC includes an electrode and a TFLC optical component. The TFLC component includes at least one TFLC electro-optic material. The interposer is coupled with the TFLC PIC and the additional IC. At least one of the TFLC PIC or the interposer is configured such that a portion of the TFLC PIC is separated from an other component by an air cladding region.

### CROSS REFERENCE TO OTHER APPLICATIONS

This application claims priority to U.S. Provisional Patent Application No. 63/676,741 entitled PACKAGING OF THIN FILM LITHIUM-CONTAINING PHOTONICS INTEGRATED CIRCUITS filed Jul. 29, 2024 which is incorporated herein by reference for all purposes.

### BACKGROUND OF THE INVENTION

Lithium-containing (LC) electro-optic materials, such as lithium niobate (LN) and/or lithium tantalate (LT), may be desired to be used in photonics integrated circuits. Thin film lithium-containing (TFLC) materials may include materials such as thin film LN (TFLN) and/or thin film LT (TFLT). TFLC photonic integrated circuits (TFLC PICs) are also desired to be integrated with other components. For example, a TFLC PIC may be desired to be used in conjunction with a silicon-based driver circuit and/or a silicon-based receiver. However, challenges remain in combining TFLC devices with silicon-based integrated circuits. For higher data rates, for example on the order of up to 400 Gbps, shorter electrical channels are desired. Thus, the TFLC PIC may be desired to be very close to the silicon-based devices. Thus, packaging TFLC PICs with silicon devices may be desired for such higher data rate devices. However, the TFLC device may be subject to optical and/or microwave/RF losses (losses in the electrical signal used to modulate the optical signal in the waveguides) that are greater than desired when integrated with silicon-based ICs. Moreover, existing methods of 2.5D semiconductor packaging may be expensive or incompatible with TFLN PIC integration. For example, techniques such as through-silicon via solutions may be challenging to fabricate and add unwanted parasitics to the devices. Accordingly, what is needed is an improved method for integrating TFLC PICS.

### BRIEF DESCRIPTION OF THE DRAWINGS

Various embodiments of the invention are disclosed in the following detailed description and the accompanying drawings.

FIG. 1 is a diagram depicting an embodiment of an integrated photonics package.

FIGS. 2A-2B depict an embodiment of a portion of a thin film lithium-containing optical device usable in a photonics package.

FIGS. 3A-3B depict an embodiment of an integrated photonics package including a thin film lithium-containing photonics integrated circuit.

FIGS. 4A-4B depict an embodiment of an integrated photonics package including a thin film lithium-containing photonics integrated circuit.

FIGS. 5A-5B depict an embodiment of an integrated photonics package including a thin film lithium-containing photonics integrated circuit.

FIGS. 6A-6B depict an embodiment of an integrated photonics package including a thin film lithium-containing photonics integrated circuit.

FIGS. 7A-7B depict an embodiment of an integrated photonics package including a thin film lithium-containing photonics integrated circuit.

FIGS. 8A-8B depict an embodiment of an integrated photonics package including a thin film lithium-containing photonics integrated circuit.

FIGS. 9A-9B depict an embodiment of an integrated photonics package including a thin film lithium-containing photonics integrated circuit.

FIGS. 10A-10B depict an embodiment of an integrated photonics package including a thin film lithium-containing photonics integrated circuit.

FIGS. 11A-11B depict an embodiment of an integrated photonics package including a thin film lithium-containing photonics integrated circuit.

FIGS. 12A-12B depict an embodiment of an integrated photonics package including a thin film lithium-containing photonics integrated circuit.

FIG. 13 depicts an embodiment of an integrated photonics package including a thin film lithium-containing photonics integrated circuit.

FIGS. 14A-14C depict embodiments of thin film lithium-containing photonics integrated circuits usable in photonic packages.

FIGS. 15A-15B depict an embodiment of an integrated photonics package including a thin film lithium-containing photonics integrated circuit.

FIG. 16 depicts an embodiment of an integrated photonics package including a thin film lithium-containing photonics integrated circuit.

FIG. 17 depicts an embodiment of an integrated photonics package including a thin film lithium-containing photonics integrated circuit.

FIGS. 18A-18B depict an embodiment of an integrated photonics package including a thin film lithium-containing photonics integrated circuit.

FIG. 19 is a flow-chart depicting an embodiment of a method for providing a photonics package including a thin film lithium-containing photonics integrated circuit.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A photonics package is described. The photonics package includes a thin film lithium-containing (TFLC) photonics integrated circuit (PIC), an additional integrated circuit, and an interposer. The TFLC PIC includes an electrode and a TFLC optical component. The TFLC component includes at least one TFLC electro-optic material. The interposer is coupled with the TFLC PIC and the additional IC. At least one of the TFLC PIC, the additional integrated circuit, or the interposer is configured such that a portion of the TFLC PIC is separated from an other component by an air cladding region. In some embodiments, the portion of the TFLC PIC separated from the other component by the air cladding region is aligned with the electrodes. In some embodiments, the TFLC PIC is flip-chip coupled with the interposer.

In some embodiments, the air cladding region includes at least one of air, vacuum, a gas, or a non-reactive gas. The non-reactive gas is nonreactive with respect to the portion of the TFLC PIC aligned with the electrode. The air cladding region may have a thickness of at least fifty micrometers and not more than one thousand micrometers. In some embodiments, the thickness of the air cladding region is at least one hundred micrometers and not more than six hundred micrometers. The air cladding region may be at least two hundred micrometers and/or not more than five hundred micrometers thick. In some embodiments, the air cladding layer may be not more than four hundred micrometers thick. In some embodiments, the TFLC PIC includes a lid. The air cladding region is between the portion of the TFLC PIC aligned with the electrode and a surface of the lid.

In some embodiments, the electrode is aligned with a portion of the interposer. In such embodiments, the interposer further includes a cutout region that includes the portion of the interposer aligned with the electrode. The interposer may have a first surface. In such embodiments, the TFLC PIC is coupled with the interposer such that a surface of the TFLC PIC is aligned with the first surface. In some embodiments, the electrode is aligned with a portion of the interposer. In such embodiments, the TFLC PIC is embedded in the interposer such that the air cladding region separates the portion of the interposer from the TFLC PIC.

A TFLC PIC is described. The TFLC PIC includes an electrode and a TFLC optical component. The TFLC component includes at least one TFLC electro-optic material. The TFLC PIC is integrated with an additional integrated circuit (IC) and an interposer coupled with the TFLC PIC and the additional IC. The TFLC PIC and/or the interposer is configured such that a portion of the TFLC PIC is separated from an other component by an air cladding region. In some embodiments, the portion of the TFLC PIC separated from the other component by the air cladding region is aligned with the electrodes. The air cladding region may include at least one of air, vacuum, a gas, or a non-reactive gas, the non-reactive gas being nonreactive with respect to the portion of the TFLC PIC aligned with the electrode. In some embodiments, the air cladding region has a thickness of at least fifty micrometers and not more than one thousand micrometers.

The electrode may be aligned with a portion of the interposer. In some such embodiments, the interposer further includes a cutout region including the portion of the interposer aligned with the electrode. The interposer may have a first surface. In such embodiments, the TFLC PIC is coupled with the interposer such that a surface of the TFLC PIC is aligned with the first surface. The TFLC PIC may include a lid. The air cladding region is between the portion of the TFLC PIC aligned with the electrode and a surface of the lid. In some embodiments, the electrode is aligned with a portion of the interposer. In such embodiments, the TFLC PIC is embedded in the interposer such that the air cladding region separates the portion of the interposer from the TFLC PIC.

A method is described. The method incudes coupling a TFLC PIC with an interposer and an additional IC. The TFLC PIC includes an electrode and a TFLC optical component, which includes TFLC electro-optic material(s). The TFLC PIC and/or the interposer is configured such that a portion of the TFLC PIC is separated from an other component by an air cladding region. In some embodiments, the portion of the TFLC PIC separated from the other component by the air cladding region is aligned with the electrodes.

In some embodiments, the electrode is aligned with a portion of the interposer. In such embodiments, the interposer further includes a cutout region including the portion of the interposer aligned with the electrode. Coupling the TFLC PIC with the interposer and additional IC further includes aligning the cutout region to the portion of the TFLC PIC aligned with the electrode and affixing the TFLC PIC and the interposer. In some embodiments, the TFLC PIC includes a lid. The air cladding region is between the portion of the TFLC PIC aligned with the electrode and a surface of the lid. In some embodiments, coupling the TFLC PIC with the interposer and the additional IC further includes flip-chip coupling the TFLC PIC with the interposer.

Various features of the electro-optic devices are described herein. One or more of these features may be combined in manners not explicitly described herein. The optical devices described herein may be formed using electro-optic materials, such as thin film lithium-containing (TFLC) electro-optical materials. For example, thin film lithium niobate (TFLN) and/or thin film lithium tantalate (TFLT) may be used for the components described. TFLC optical devices use layer(s) of TFLC material that may have a thickness not exceeding three micrometers prior to fabrication of components, such as waveguides, therein. In some embodiments, the TFLC may have a thickness of not greater than one micrometer prior to fabrication of components therein. In general, components are thinner. For example, a TFLC waveguide in an optical modulator may include a ridge and a slab portion. The total thickness of the waveguide (e.g. ridge height plus slab height) may be less than one micrometer as-fabricated. In some embodiments, the total thickness of the waveguide may not exceed five hundred nanometers as-fabricated. In some embodiments, the total thickness of the waveguide may not exceed four hundred nanometers as-fabricated. In some embodiments, the total thickness of the waveguide may not exceed three hundred nanometers as-fabricated. Other thicknesses are possible. Because TFLN is frequently used in such TFLC devices, the systems, methods, and techniques described herein may be discussed in the context of TFLN. However, one of ordinary skill in the art will recognize that the techniques described herein apply to other TFLC devices (e.g. TFLT devices). Wherever a TFLN or thin film lithium niobate integrated circuit is described, a thin film lithium tantalate integrated circuit or other lithium-containing integrated circuit may also be used.

Although primarily described in the context of TFLC electro-optic materials, such as TFLN and TFLT, other nonlinear optical materials may be used in the optical devices described herein. For example, other ferroelectric nonlinear (e.g. second order) optical materials may also be desired to be used in, e.g., waveguides, modulators, polarization rotators, and/or mode converters. Such ferroelectric nonlinear optical materials may include but are not limited to potassium niobate (e.g. KNbO₃), gallium arsenide (GaAs), potassium titanyl phosphate (KTP), lead zirconate titanate (PZT), and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, and barium titanate. In other embodiments, other nonlinear optical materials having analogous optical characteristics may be used.

In some embodiments, waveguides and other structures described herein are low optical loss optical structures. For example, a waveguide may have a total optical loss of not more than 10 dB through the portion of waveguide (e.g. when biased at maximum transmission and as a maximum loss) in proximity to electrodes used in modulating the optical signal. The total optical loss is the optical loss in a waveguide through a single continuous electrode region (e.g. as opposed to multiple devices cascaded together). In some embodiments, the waveguide has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, the waveguide has an optical loss of not more than 3 dB/cm (e.g. on average). In some embodiments, the nonlinear material(s) in the waveguides has an optical loss of not more than 2.0 dB/cm. In some such embodiments, the waveguide has an optical loss of not more than 1.0 dB/cm. In some embodiments, the waveguide has an optical loss of not more than 0.5 dB/cm. In some embodiments, the low optical losses are associated with a low surface roughness of the side walls of the waveguides.

The waveguides and other optical structures may have improved surface roughness. For example, the short range root mean square surface roughness of a sidewall of the rib may be less than ten nanometers. In some embodiments, this root mean square surface roughness is not more than five nanometers. In some cases, the short range root mean square surface roughness does not exceed two nanometers. In some embodiments, a waveguide includes a rib portion and a slab portion. The height of such a rib portion is selected to provide a confinement of the optical mode such that there is a 10 dB reduction in intensity from the intensity at the center of the rib at ten micrometers from the center of the rib. For example, the height of the rib is on the order of a few hundred nanometers in some cases. However, other heights are possible in other embodiments. Various other optical components may be incorporated into the waveguide to provide the desired functionality. For example, the waveguide may have wider portion(s) for accommodating multiple modes or performing other functions.

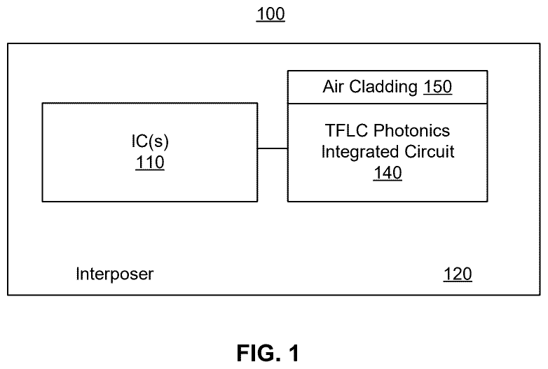

FIG. 1 is a block diagram depicting an embodiment of photonics package 100. Photonics package 100 includes integrated circuit(s) (IC(s)) 110, interposer 120, and TFLC photonics integrated circuit (PIC) 140. Other components are generally present but are not shown for clarity. For example, photonics package 100 may include electrical input and output (I/O) and/or optical I/O (e.g., a fiber array unit). Although one TFLC PIC 140 is shown, multiple TFLC PICs may be present.

IC(s) 110 may include silicon-based IC(s) and/or other IC(s). For example, IC(s) 110 may include a silicon-based transmitter IC (e.g., an electrical IC that includes driver and/or other circuitry) and/or a silicon-based receiver circuit. IC(s) 110 may also include silicon (or other) support structures and/or interposers which provide mechanical support and/or electrical connection to TFLC PIC and/or other ICs. IC(s) 110 may be electrically and/or optically connected with TFLC PIC 140. Although shown as directly coupled, IC(s) 110 and TFLC PIC 140 may be coupled through interposer 120.

Interposer 120 may be used to mechanically and/or electrically couple IC(s) 110 and TFLC PIC 140. Interposer 120 may be an organic interposer. For example, such an interposer 120 includes organic material(s), such as polyimide, epoxy, laminates, and/or other materials that may be analogous to those used in printed circuit boards (PCBs). Other materials, such as glass and/or silicon might be used for interposer 120 in some embodiments. In some embodiments, IC(s) 110 and/or TFLC PIC 140 are electrically connected to interposer 120 through solder bumps and/or wire bonds. Interposer 120 may include electrical interconnects, for example in one or more redistribution layers (RDLs). For example, electrical signals from IC(s) 110 may be provided to interposer 120 via solder bump connections, be routed through interposer 120 via RDL(s), and provided to TFLC PIC 140 from interposer 120 via solder bump and/or wire bond connections. In some embodiments, interposer 120 is mechanically robust. For example, interposer 120 may have a thickness of at least three hundred micrometers through not more than 20 millimeters. In some embodiments, interposer 120 has a thickness of at least one hundred micrometers. The thickness of interposer 230 may be less than four millimeters or less than two millimeters. In some embodiments, interposer 120 has a thickness of not more than two hundred micrometers.

TFLC PIC 140 includes TFLC optical component(s) (not shown in FIG. 1) and electrodes (not shown in FIG. 1). For example, TFLC PIC 140 may include waveguides, splitters, bends, mode converters, polarization beam rotators, and/or other optical components used to transmit and/or modify the optical signal carried by TFLC PIC 140. Electrodes may be used in conjunction with waveguide(s), for example for optical modulation (e.g. via the electro-optic effect).

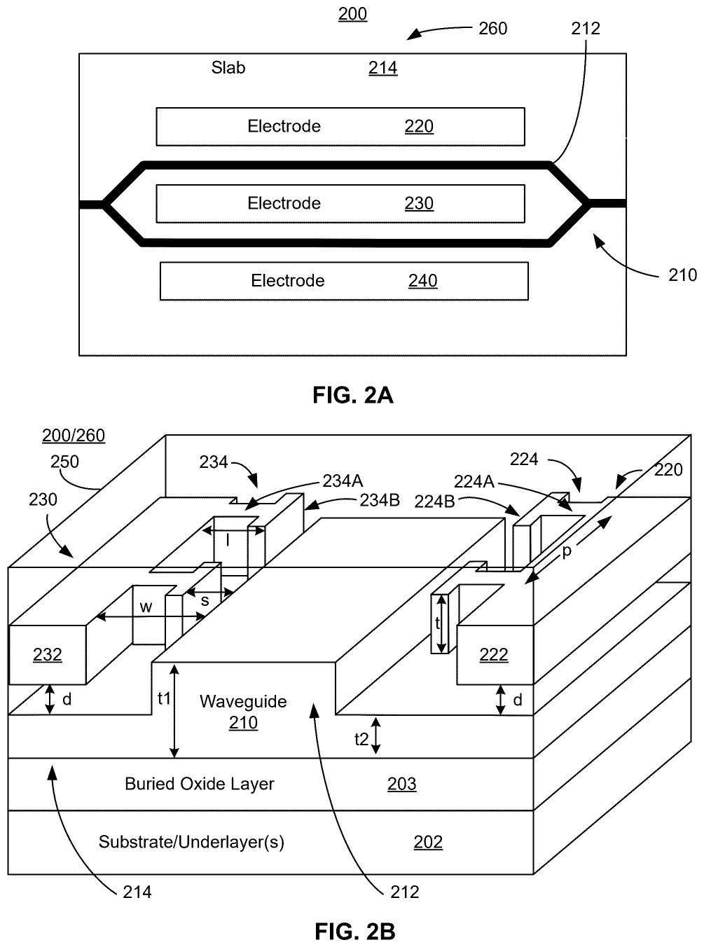

For example, FIGS. 2A-2B depict a portion of an embodiment of photonics integrated circuit (PIC) 200 using TFLC electro-optic material(s) and that may be integrated with as part of a photonics package. For example, photonics device 200 may be used as part or all of a modulator used in TFLC PIC 140. FIG. 2B is a perspective view of a portion of photonics device 200. FIGS. 2A-2B are not to scale. Only a portion of photonics device 200 is shown. Photonics device 200 may include other and/or additional structures that are not shown for simplicity. Further, although particular configurations are shown, other configurations are possible.

Photonics device 200 is on a substrate structure that includes substrate 202 and buried oxide (BOX) layer 203. In some embodiments, substrate 202 is a silicon substrate. Substrate 202 may also include other layers. In some embodiments, substrate 202 may be glass, quartz, silicon-on-insulator, and/or other low microwave loss dielectrics. Substrate 202 may be one hundred micrometers or more thick. BOX layer 203 may be a silicon dioxide layer. In some embodiments, BOX layer 203 may be at least three micrometers thick and not more than fifteen micrometers thick. In some embodiments, the substrate structure may be configured differently. Also shown is cladding 250, which may be formed of silicon dioxide.

Photonics device 200 includes waveguide 210 and electrodes 220, 230, and 240. In some embodiments, photonics device 200 may be configured as or include a modulator (or portion thereof). Thus, photonics device 200 may be considered to include modulation region 260. Other regions, such as a bend region, may be present. Modulator 200 is shown as configured as a Mach-Zehnder modulator. Other configurations for phase and/or amplitude modulation are possible. For clarity, only the portion of electrodes 220, 230, and 240 proximate to waveguide 210 are shown. Stated differently, electrodes 220, 230, and 240 are shown in modulation region 260.

Waveguide 210 may be considered to include ridge 212 as well as slab 214. Ridge 212 has a height, t1, greater than the height, t2, of slab 214. Although shown as rectangles, ridge 212 and/or slab 214 have other shapes, such as trapezoids and/or other analogous shapes. In addition, slap 212 may terminate closer to ridge 214 than at least a portion of electrode(s) 220 and/or 230. Photonics device 200 includes electro-optic optic material(s), such as TFLC materials (e.g. TFLN and/or TFLT). More specifically, ridge 212 and slab 214 include electro-optic materials, such as TFLC materials. In some embodiments, the waveguide 210 consists of TFLC materials such as TFLN and/or TFLT. In the embodiment shown, ridge 212 and slab 214 are formed of the same material. In some embodiments, ridge 212 and slab 214 may include different materials. Waveguide 210, and more particularly ridge 212, may be used to propagate the optical signal. The optical mode may be well confined to ridge 212 and/or ridge 212 in combination with a portion of nearby slab 214. Slab 214 provides increased electro-optic modulation efficiency. In particular, slab 214 aids in directing the electric field generated by the signal(s) in electrodes 220, 230, and 240 to optical mode 213 in modulation region 260. Thus, a higher modulation for a given electric field may be obtained. As a result, V-pi (and V-pi-L) may be reduced.

Electrodes 220, 230, and 240 may carry electrode signals used to modulate the optical signals (e.g. light) carried by waveguide 210 via electro-optic modulation. Electrode(s) 220 and/or 230 are configured to carry a traveling wave (e.g. a microwave or RF electrode signal) that modulates the optical signal carried by waveguide 210 via the electro-optic effect. For example, the electrode signals may provide electro-optic modulation up to frequencies of 100 GHz, 200 GHz, 500 GHZ or higher. In some embodiments, modulator 210 may provide modulation from at or near DC to frequencies of 100 GHz, 200 GHz, 500 GHz, or more. The modulation may also have a wide window, for example an operation bandwidth of at least 20 GHz. Electrode signals carried by electrodes 220, 230, and 240 may be configured in a variety of manners. For example, electrode 230 may carry a microwave signal, while electrodes 220 and 240 are ground. Electrode 230 may carry a signal of a first polarity, while electrodes 220 and 240 carry signals of opposite polarity (i.e. in a differential configuration). Other configurations (including but not limited to another number of electrodes) are possible.

Electrodes 220, 230, and/or 240 may include extensions. Embodiments of analogous electrodes may be found in co-pending U.S. patent application Ser. No. 17/843,906, entitled ELECTRO-OPTIC DEVICES HAVING ENGINEERED ELECTRODES, which is a continuation of U.S. patent application Ser. No. 17/102,047 entitled ELECTRO-OPTIC DEVICES HAVING ENGINEERED ELECTRODES, filed Nov. 23, 2020, which claims priority to U.S. Provisional Patent Application No. 62/941,139 entitled THIN-FILM ELECTRO-OPTIC MODULATORS filed Nov. 27, 2019, U.S. Provisional Patent Application No. 63/033,666 entitled HIGH PERFORMANCE OPTICAL MODULATORS filed Jun. 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed Nov. 12, 2020, all of which are incorporated herein by reference for all purposes. In other embodiments, extensions may be omitted from some or all of electrodes 220, 230, and/or 240. Electrodes 220, 230, and 240 may carry differential electrical signals, a single electrical signal (e.g. a signal and ground), or other signal(s).

Electrode 230 includes a channel region 232 and extensions 234 (of which only one is labeled in FIG. 2B). Similarly, electrode 220 includes channel region 222 and extensions 224 (of which only one is labeled in FIG. 2B). In some embodiments, extensions 224 or 234 may be omitted from electrode 220 or electrode 230, respectively. Extensions 224 and 234 may be closer to ridge 212 than channel region 222 and 232, respectively, are. For example, the distance s from extensions 224 and 234 to waveguide ridge 212 is less than the distance w from channels 222 and 232 to waveguide ridge 212. Extensions 224 may be closer to electrode 230 (e.g. extensions 234 and/or channel 232) than channel 222 is. Similarly, extensions 234 may be closer to electrode 220 e.g. extensions 224 and/or channel 222) than channel 232 is.

Extensions 224 and 234 are in proximity to ridge 212. For example, extensions 224 and 234 are a vertical distance, d from slab 214 of TFLC waveguide 210. The vertical distance to TFLC waveguide 210 may depend upon the cladding 250 used. The distance d is highly customizable in some cases. For example, d may range from zero (or less if electrodes 220 and 230 contact or are embedded in slab portion 214) to greater than the height of ridge 212. In embodiments in which slab 214 terminates closer to ridge 212 than channel regions 222 and 232, d may be zero (same level as the top surface of slab 214), positive (further from substrate 202 than the top surface of slab 214), or negative (further from substrate 202 than the top surface of slab 214). However, d is generally still desired to be sufficiently small that electrodes 220 and 230 can apply the desired electric field to ridge 212. Extensions 224 and 234 are also a distance, s, from ridge 212. In some embodiments, s<0 (i.e., extensions 224 and/or 234 may extend over the top of ridge 212 or below waveguide 210). Extensions 224 and 234 are desired to be sufficiently close to TFLC waveguide 210 (e.g. close to ridge 212) that the desired electric field and index of refraction change can be achieved. However, extensions 224 and 234 are desired to be sufficiently far from TFLC waveguide 210 (e.g. from ridge 212) that their presence does not result in undue optical losses. Although shown next to ridge 212, extensions 224 and/or 234 may extend above and/or below ridge 212.

In the embodiment shown, extensions 224 have a connecting portion 224A and a retrograde portion 224B. Retrograde portion 224B is so named because a part of retrograde portion may be antiparallel to the direction of signal transmission through electrode 220. Similarly, extensions 234 have a connecting portion 234A and a retrograde portion 234B. Thus, extensions 224 and 234 have a “T”-shape. In some embodiments, other shapes are possible. For example, extensions 224 and/or 234 may have an “L”-shape, may omit the retrograde portion, may be rectangular, trapezoidal, parallelogram-shaped, may partially or fully wrap around a portion of ridge 212, and/or have another shape. Similarly, channel regions 222 and/or 232, which are shown as having a rectangular cross-section, may have another shape. Further, extensions 224 and/or 234 may be different sizes. Although all extensions 224 and 234 are shown as the same distance from ridge 212, some of extensions 224 and/or some of extensions 234 may be different distances from ridge 212. Channel regions 222 and/or 232 may also have a varying size.

Also indicated in FIG. 2B is thickness, t, of extensions 224 and 234. In the embodiment shown, channels 222 and 232 have the same thickness. In some embodiments, the thickness of extensions 224 and/or 234 may vary. For example, extensions 224 may be thinner (or thicker) than extensions 234. Further, different extensions 224 may have different thicknesses. Similarly, different extensions 234 may have different thicknesses. Extensions 224 and/or 234 may also have a different thickness than channels 222 and/or 232. For example, extensions 224 and/or 234 may be thinner (or thicker) than channels 222 and/or 232. Different portions of extensions 224 and/or 234 may also have different thicknesses. For example, retrograde portions 224B and/or 234B may be thinner (or thicker) than connecting portions 224A and/or 234B. Thus, TFLC PICs 200 and 140 may have a variety of configurations, components, and functions. Performance of TFLC PICs 200 and 140 may be superior to that of other, non-TFLC PICS.

Referring back to FIG. 1, photonics package 100 also includes air cladding region 150. TFLC PIC 140 (which may be or include photonics PIC 200) is integrated with IC(s) 110, interposer 120, and air cladding region 150 in photonics package 100. Air cladding region 150 is aligned with a portion of TFLC PIC 140. In some embodiments, the air cladding region is aligned with at least a portion of the electrodes of TFLC PIC 140. Thus, a portion of TFLC PIC 140 (e.g., the portion aligned with the electrode(s) and/or portion(s) of the electrodes) is separated from an other component by air cladding region 150. In some embodiments, air cladding region 150 is aligned only with the portion of TFLC PIC 140 aligned with the electrodes. In some embodiments, the portion of TFLC PIC 140 aligned with air cladding region 150 includes but is not limited to the portion of TFLC PIC 140 aligned with the electrodes. In some embodiments, air cladding region 150 may be aligned with substantially all of TFLC PIC 140. For example, only connections (e.g. via solder bumps) near edges of TFLC PIC 140 may be in physical contact with other portions of photonics package 100. In some embodiments, air cladding region 150 may be aligned with photodiodes.

In some embodiments, air cladding region 150 may be formed by the configuration(s) of TFLC PIC 140, interposer 120, and/or IC(s) 110. For example, TFLC PIC 140 and/or interposer 120 may be configured such that the portion of TFLC PIC 140 aligned with the electrode(s) is separated from another component (e.g. IC(s) 110 and/or interposer 120) by air cladding region 150. For example, for TFLC PIC 200 used in photonics package 100, air cladding region 150 may be adjacent to cladding 250 proximate to electrodes 220, 230, and/or 240. Although termed an “air cladding” region, region 150 may not include air. In some embodiments air cladding region 150 includes air, vacuum, a gas, and/or a non-reactive gas. The non-reactive gas is nonreactive with respect to the portion of TFLC PIC 140 aligned with the electrode and adjacent to air cladding region 150.

Air cladding region 150 may have a thickness of at least fifty micrometers and not more than one thousand micrometers. In some embodiments, the thickness of air cladding region 150 is at least one hundred micrometers. In some embodiments, air cladding region 150 is at least two hundred micrometers thick. Air cladding region 150 may be not more than six hundred micrometers thick. Air cladding region 150 may be not more than five hundred micrometers thick. In some embodiments, air cladding region 150 may be not more than four hundred micrometers thick. In some embodiments, the thickness of air cladding region 150 is selected to reduce or eliminate unwanted interactions with the microwave mode carried by the electrodes. Stated differently, the thickness (and in at least some embodiments width) of air cladding region 150 may be sufficiently large that most (e.g. more than half) through all of the microwave mode on the same side of the electrodes as air cladding region 150 is not further from the electrodes than air cladding region 150. For example, the microwave mode may be considered to extend tens of microns through hundred(s) of microns outside of the electrodes. The microwave mode may interact with structures in this region, resulting in microwave losses. Air cladding region 150 may mitigate or eliminate these losses. For example, underfill (not shown) is frequently used in attaching TFLC PIC 140 to interposer 120. Such an underfill may result in significant microwave losses. However, air cladding region 150 may replace such an underfill (or other structures) in this region. As a result, microwave losses may be significantly reduced. Performance may be improved.

Air cladding region 150 may be formed by the configuration of TFLC PIC 140, IC(s) 110, and/or interposer 120. For example, TFLC PIC 140 may include a lid that allows for the presence of air cladding region 150 between the lid and a portion of TFLC PIC 140 aligned with the electrodes. In such embodiments, air cladding region 150 is between the portion of TFLC PIC 140 aligned with the electrode and a surface of the lid. In some embodiments, interposer 120 may include a cutout region. The cutout region that includes the portion of interposer 120 aligned with the electrode. The cut out may be a cavity in interposer 120 or may extend through the interposer 120. Thus, the cutout may form some or all of air cladding region 150. Such cutouts may also prevent underfill from flowing over a portion of TFLC PIC 140. In some embodiments, TFLC PIC 140 is embedded in interposer 120 such that air cladding region 150 separates a portion of interposer 120 from the TFLC PIC 140. Thus, photonics package 100 may include air cladding region 150. Air cladding region 150 may improve RF performance of, for example, a traveling wave modulator in TFLC PIC 140. For example, RF losses may be reduced.

In some embodiments in which TFLC PIC 140 is embedded in interposer 120, TFLC PIC 140 may be placed such that a surface (e.g., the top surface) of TFLC PIC 140 is aligned with a surface of interposer 120. For example, the top surface of TFLC PIC 140 (e.g., the surface opposite to substrate 202) may be flush with (e.g. within ±2 micrometers, within ±5 micrometers, or ±10 micrometers) a top surface of interposer 120. In such embodiments, TFLC PIC 140 may be placed in a recessed region of interposer 120. ICs 110 may be placed on the top surfaces of TFLC PIC 140 and/or interposer 120. As a result, electrical and/or other IC(s) 110 and the chip pads of TFLC PIC 140 may be directly attached to one another through (e.g. copper pillars, gold bumps, solder bumps, etc.). This may facilitate integration of TFLC PIC 140 with other IC(s) 110. Consequently, manufacturing and performance may be further improved.

Air cladding region 150 may also facilitate the use of other devices in conjunction with TFLC PIC 140. In some instances, TFLC PIC 140 may utilize photodiodes (PDs), such as monitoring photodiodes used to detect and monitor the optical signal (e.g., from a tap). These photodiodes are generally affixed to a top surface of TFLC PIC 140. Consequently, flip-chip bonding would be complicated by the presence of such photodiodes. Air cladding region 150 may be extended to include the region of the PDs. Thus, the PDs may be assured to have sufficient clearance for the PDs TFLC PIC 140 is flip-chip bonded with interposer 120.

In some embodiments, TFLC PIC 140 is flip-chip coupled with interposer 120. Thus, in addition to air cladding region 150, photonics package 100 is configured such that connections between TFLC PIC 140 and interposer may be made through solder bumps and/or wire bonding. As a result, low loss and short connection path interconnects through interposer 120 may be present. For example, a low loss insertion path between IC(s) 110 (e.g., a digital signal processor (DSP) or other electrical IC) and TFLC PIC 140 may be established via interconnects in interposer 120. These connections may be achieved without using technology such as through silicon vias (TSVs). TSVs are challenging to fabricate and may add unwanted parasitics. Thus, such issues may be mitigated or avoided. Further, connections can be arranged on the flip-chip bonded TFLC PIC 140 as desired. A single flip chip attach step can make RF connections on one edge of TFLC PIC 140, and power/signal connections on one or two of the other edges. These connections may serve as a mechanical support for the die of TFLC PIC 140. Thus, the length of the signal path between optical components such as a TFLN Mach-Zehnder (or other) modulator in TFLC PIC 150 and the EIC bumps may be optimized (i.e. reduced). This provides an extremely low insertion loss path for the high-speed data.

Thus, photonics package 100 may have improved performance and/or manufacturability. In addition to the benefits provided through the use of TFLC PIC having the properties described herein, photonics package 100 may have improved performance. Air cladding region 150 may provide improved RF performance (e.g., reduced RF losses) for the microwave signal(s) carried by the electrode(s) of modulator(s) in TFLC PIC 140. Further, air cladding region 150 may provide additional clearance for devices such as monitor PDs on the surface of TFLC PIC 140. Air cladding region 150 may be over the entire surface of the TFLC PIC 140 or may be directly over the electrodes and may not cover at least some other areas of the TFLC PIC 140. Thus, improved flexibility of design may be achieved. Because TFLC PIC 140 may be flip-chip bonded to interposer 120 while maintaining the presence of air cladding region 150. Thus, manufacturing may be enhanced while achieving these benefits. Further, integration in connection with air cladding region 150 may provide a mechanism for shorter interconnects between, e.g., IC(s) 110 and TFLC PIC 140 via interposer 120 and solder connections. Thus, high frequency performance (e.g. up to 400 GHz microwave signals or higher) may be improved.

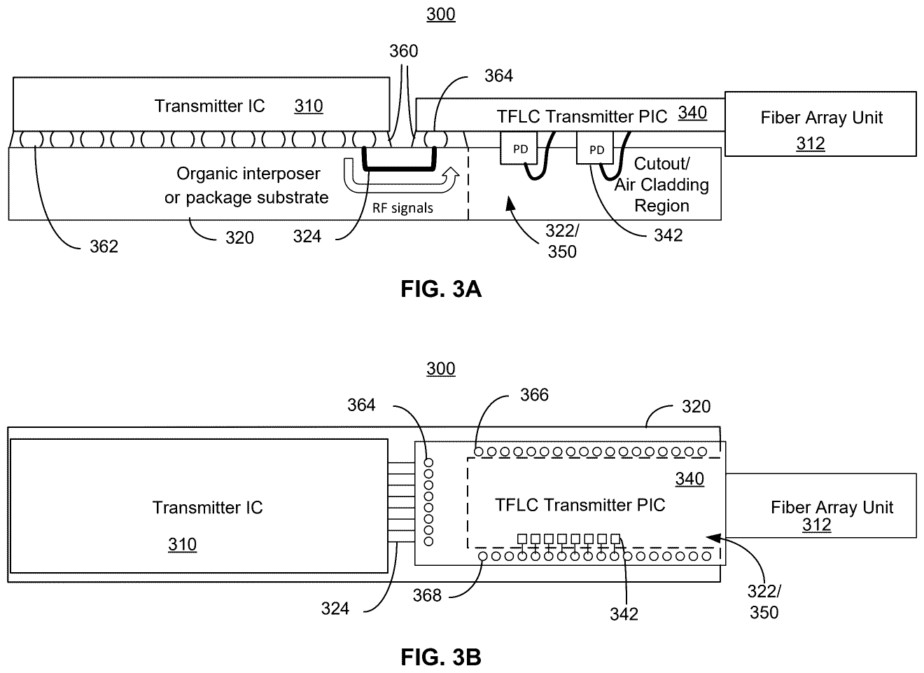

FIG. 3A-FIG. 18B depict embodiments of photonics packages that are analogous to photonics package 100. Although configurations having various combinations of features are shown, one of ordinary skill in the art will recognize that other combinations and/or configurations of the features described herein may be used.

FIGS. 3A-3B depict an embodiment of integrated photonics package 300 including TFLC PIC 340. FIG. 3A depicts a cross-sectional view, while FIG. 3B depicts a top view. Photonics package 300 is analogous to photonics package 100. Thus, photonics package 300 includes additional IC 310, interposer 320, TFLC PIC 340, and air cladding region 350 that are analogous to IC(s) 110, interposer 120, TFLC PIC 140, and air cladding region 150. Consequently, IC 310, interposer 320, TFLC PIC 340, and air cladding region 350 may have an analogous structure and function to IC(s) 110, interposer 120, TFLC PIC 140, and air cladding region 150, respectively. Thus, TFLC PIC 340 may be analogous to TFLC PIC 200 and have some or all of the benefits thereof. Also shown is fiber array unit 312 that may be used in providing optical signals to and receiving optical signals from TFLC PIC 340.

In the embodiment shown, TFLC PIC 340 is a TFLN transmitter PIC. Thus, IC 310 is a transmitter IC. For example, IC 310 may include driver circuitry for providing a However, other TFLC PIC(s) may be present in addition to or in lieu of a TFLN transmitter PIC. Similarly, other IC(s) may be present in addition to or in lieu of a transmitter IC. TFLC PIC 340 includes PDs 342 (of which only one is labeled). In the embodiment shown, PDs 342 are affixed and wire bonded to TFLC PIC 340. Other techniques for attaching and/or for providing electrical connection to PDs 342 may be used. Although different numbers of PDs are shown in FIGS. 3A and 3B, the specific number of PDs may be considered intended to show that multiple PDs may be present.

TFLC PIC 364 and IC 310 are electrically and mechanically connected to interposer 320 via solder bumps 362, 364, 366, and 368 (only one of which is labeled for each set of solder bumps). In addition, underfill 360 coupled a portion of TFLC PIC 360 and IC 310 with interposer 320. In some embodiments, solder bumps 362 are used for IC 310. Solder bumps 364 on one edge of TFLC PIC 340 may be used for RF connection with IC 310. Stated differently, IC 310 may drive the electrodes in TFLC PIC 340 via solder bumps 364. Solder bumps 366 may be used for electrical connection to other components, such as a heaters (not shown and which may be used for modulation of the optical signal(s)) and/or PDs 342. Solder bumps 368 may be used for electrical connection. In some embodiments, solder bumps 368 are used for mechanical connection and/or stability. Thus, electrical connection need not be made through all bumps 362, 364, 366, and/or 368. In some embodiments, electrical and/or mechanical connection via solder bumps 362, 364, 366, and/or 368 may be made and/or arranged in another manner.

Interposer 320 includes interconnects, such as interconnect 324. Although present, other interconnects are not depicted for simplicity. Interconnect 324 may be part of an RDL within interposer 320. Interposer 320 may be an organic interposer, package substrate, or other type of interposer. Interposer 320 also includes cutout region 322 that forms air cladding region 350. In FIG. 3B, the location of cutout region 322 and air cladding region 350 are shown by a dashed line. In the embodiment shown, cutout region 322 extends through interposer 324. In some embodiments, cutout region 322 (and thus air cladding region 350) may not extend through interposer 320. In such am embodiment, cutout region 322 may be a recessed portion, or cavity, in interposer 320. Cutout 322 allows interposer 320 to have a “U” shape in the region of TFLC PIC 340. Cutout 322 provides air cladding region 350. Cutout 322 thus allows for the electrodes (and/or other components such as the waveguide) to be air clad as described in the context of air cladding region 150. Stated differently, regions vertically aligned with the portion of TFLC PIC 340 including at least the electrodes have air cladding (e.g. air, vacuum, and/or a nonreactive gas) adjoining TFLC PIC 340. For example, underfill 360 may be prevented from extending int a region aligned with electrodes for TFLC PIC 340. In addition, sufficient clearance for PDs 342 is provided by cutout 322/air cladding region 350. Further, because cutout 322 extends through interposer 320, PDs 342 may be placed on TFLC PIC 340 after TFLC PIC 340 is connected with interposer 320. In some embodiments, PDs 342 may be placed on TFLC PIC 340 before the TFLC PIC 340 is flip-chip bonded onto interposer 320.

Photonics package 300 may share the benefits of photonics package 100. For example, photonics package 300 may have reduced RF losses due to air cladding region 350 formed by cutout 322. Electrical connections between IC 310 and TFLC PIC 340 may be shorter, allowing for improved performance, particularly at higher frequencies (e.g. at least 200 GHz, at least 300 GHz, at least 400 GHz, or higher). Use of PDs 342 may be facilitated and manufacturing improved. Thus, performance and fabrication of photonics package 300 may be enhanced.

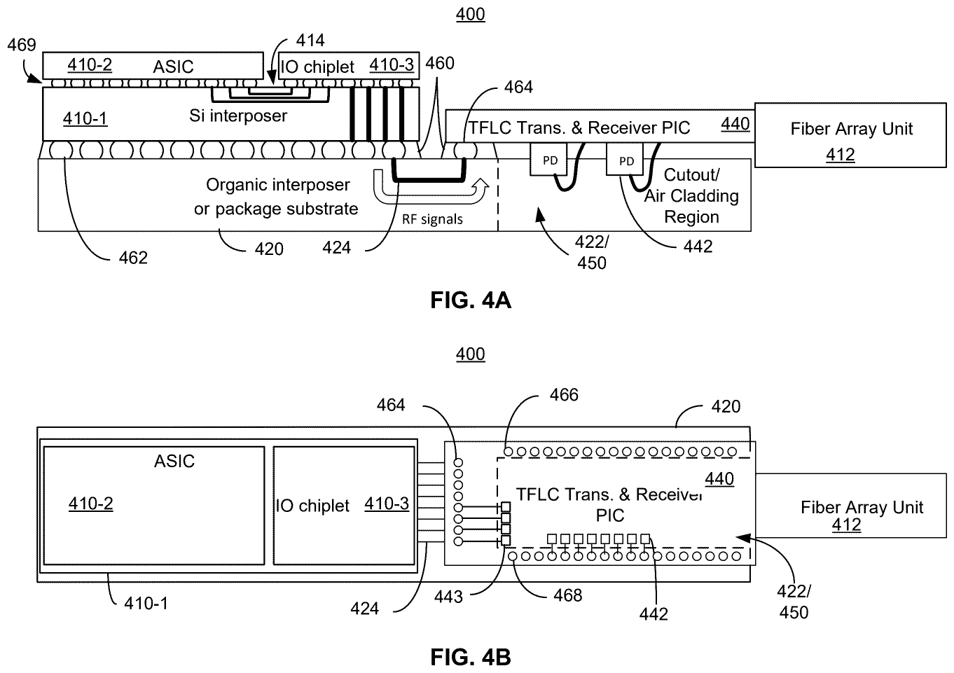

FIGS. 4A-4B depict an embodiment of integrated photonics package 400 including TFLC PIC 440. FIG. 4A depicts a cross-sectional view, while FIG. 4B depicts a top view. Photonics package 400 is analogous to photonics package(s) 100 and 300. Thus, photonics package 400 includes additional IC 410-2 and 410-3, interposer 420, TFLC PIC 440, and air cladding region 450 that are analogous to IC(s) 110, interposer 120, TFLC PIC 140, and air cladding region 150. Consequently, IC 410, interposer 420, TFLC PIC 440, and air cladding region 450 may have an analogous structure and function to IC(s) 110, interposer 120, TFLC PIC 140, and air cladding region 150, respectively. Thus, TFLC PIC 440 may be analogous to TFLC PIC 200 and have some or all of the benefits thereof. Photonics package 400 also includes fiber array unit 412, cutout 422 (indicated by a dashed line), PDs 442, underfill 460, solder bumps 462, 464, 466, and 468 analogous to fiber array unit 312, cutout 322, PDs 342, underfill 360, solder bumps 362, 364, 366, and 368, respectively.

Photonics package 400 may be a transceiver usable in a compute interconnect. Photonics package 400 thus includes additional interposer 410-1 connecting ICs 410-2 and 410-3 with interposer 420. Additional interposer 410-1 may be a silicon interposer. In some embodiments, IC 410-2 is an application specific integrated circuit (ASIC), while IC 410-3 is an input/output IC. ICs 410-2 and 410-3 may be connected to circuitry 414 (e.g. in RDLs) in interposer 410-1 via microbumps 469.

Similarly, TFLC PIC 440 is a transceiver, capable of transmit and receive functions. Thus, TFLC PIC 440 also includes high speed receiver PDs 443, of which only one is labeled. Further, solder bumps 464 may provide connectivity to both electrodes of the transmitter of TFLC PIC 440 (e.g. electrodes of a Mach-Zehnder modulator) and to PDs 443. Similarly, interconnects 424 of interposer 420 may both provide RF signals to the transmitter of TFLC PIC 440 and receive signals from PDs 443. Interposer 420 includes cutout 422 analogous to cutout 322. Thus, cutout 422 forms air cladding region 450.

Photonics package 400 may share the benefits of photonics packages 100 and/or 300. For example, photonics package 400 may have reduced RF losses due to air cladding region 450 formed by cutout 422. Electrical connections between ICs 410-2 and 410-3 and TFLC PIC 440 may be shorter, allowing for improved performance, particularly at higher frequencies. Use of PDs 442 and 443 may be facilitated and manufacturing improved. Thus, performance and fabrication of photonics package 400 may be enhanced.

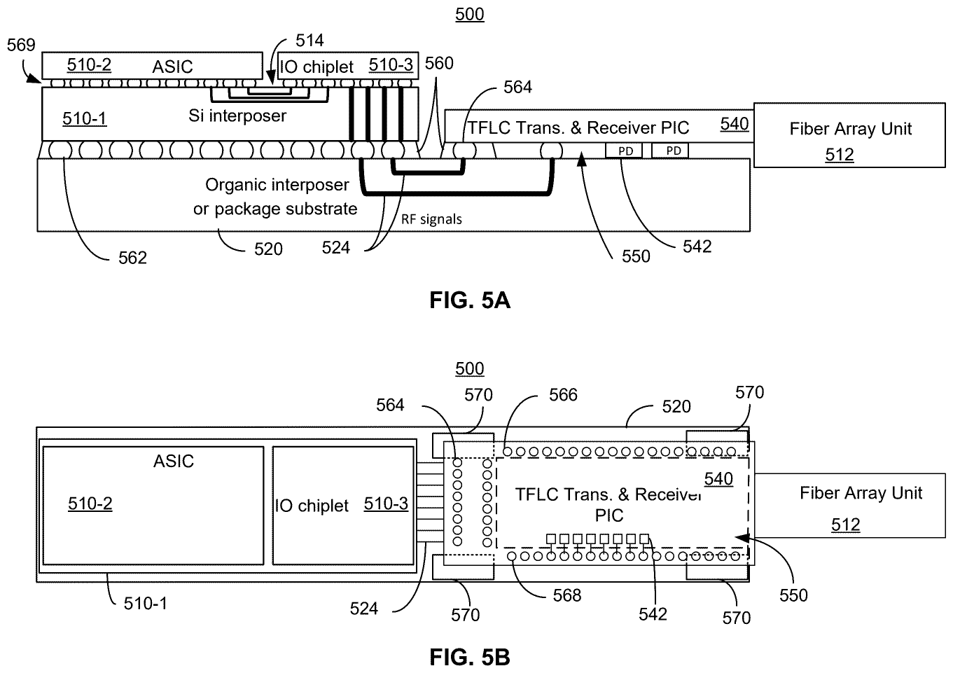

FIGS. 5A-5B depict an embodiment of integrated photonics package 500 including TFLC PIC 540. FIG. 5A depicts a cross-sectional view, while FIG. 5B depicts a top view. Photonics package 500 is analogous to photonics package(s) 100, 300, and 400. Thus, photonics package 500 includes interposer 510-1, additional IC 510-2 and 510-3, interposer 520, TFLC PIC 540, and air cladding region 550 that are analogous to interposer 410-1, IC(s) 110 and 410-2 and 410-3, interposer 120, TFLC PIC 140, and air cladding region 150. Consequently, IC 510, interposer 520, TFLC PIC 540, and air cladding region 550 may have an analogous structure and function to IC(s) 110, interposer 120, TFLC PIC 140, and air cladding region 150, respectively. Thus, TFLC PIC 540 may be analogous to TFLC PIC 200 and have some or all of the benefits thereof. Photonics package 500 also includes fiber array unit 512, PDs 542, underfill 560, solder bumps 562, 564, 566, and 568 analogous to fiber array unit 312, PDs 342, underfill 360, solder bumps 362, 364, 366, and 368, respectively.

Photonics package 500 may be a transceiver usable in a compute interconnect. Thus, photonics package 500 is analogous to photonics package 400. Photonics package 500 thus includes additional interposer 510-1, ICs 510-2 and 510-3, and microbumps 569 that are analogous to additional interposer 410-1, ICs 410-2 and 410-3, and microbumps 469. However, interposer 520 is a package substrate. Further, interposer 520 does not include a cutout. Instead, PDs 442 are as flip-chip bonded to with TFLC PIC 540 instead of being wire bonded. Thus, air cladding region 550 is formed between the top surface of interposer 550 and the top surface of flip-chip bonded TFLC PIC 540.

Air cladding region 550 is maintained through the use of underfill 570, which is only provided near the edges of TFLC PIC 540. A portion of underfill 570 is between TFLC PIC 540 and interposer 520. This portion of underfill 570 is indicated by dotted lines.

Photonics package 500 may share the benefits of photonics packages 100, 300, and/or 400. For example, photonics package 500 may have reduced RF losses due to air cladding region 550 between interposer 520 and TFLC PIC 540. Electrical connections between ICs 510-2 and 510-3 and TFLC PIC 540 may be shorter, allowing for improved performance, particularly at higher frequencies. Use of PDs 442 may be facilitated and manufacturing improved. Thus, performance and fabrication of photonics package 500 may be enhanced.

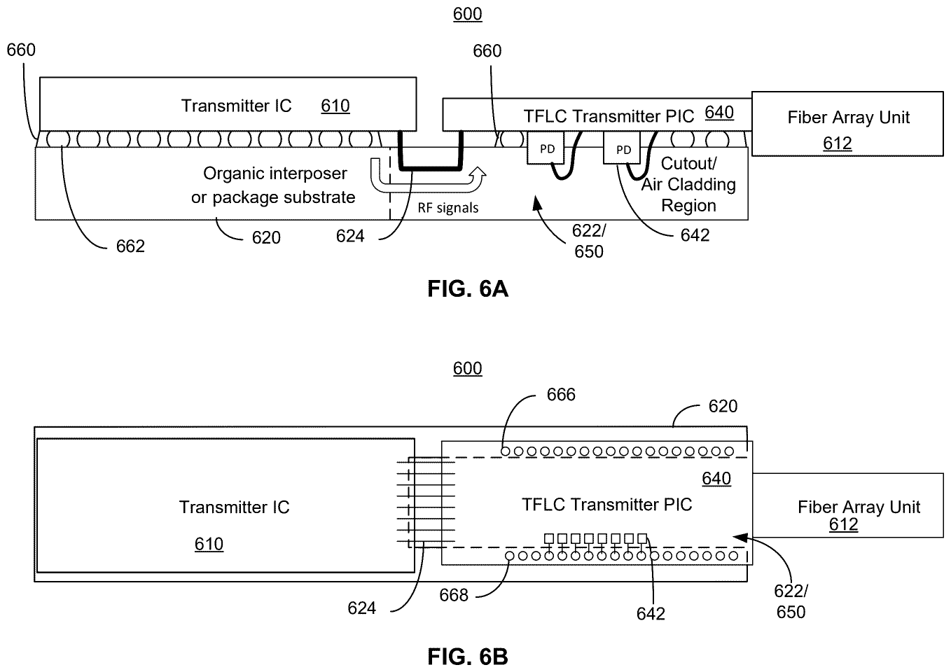

FIGS. 6A-6B depict an embodiment of integrated photonics package 600 including TFLC PIC 640. FIG. 6A depicts a cross-sectional view, while FIG. 6B depicts a top view. Photonics package 600 is analogous to photonics package(s) 100, 300, 400, and 500. Thus, photonics package 600 includes additional IC 610, interposer 620, TFLC PIC 640, and air cladding region 650 that are analogous to IC(s) 110 and 310, interposer 120, TFLC PIC 140, and air cladding region 150. Consequently, IC 610, interposer 620, TFLC PIC 640, and air cladding region 650 may have an analogous structure and function to IC(s) 110, interposer 120, TFLC PIC 140, and air cladding region 150, respectively. Thus, TFLC PIC 640 may be analogous to TFLC PIC 200 and have some or all of the benefits thereof. Photonics package 600 also includes fiber array unit 612, cutout 622 (indicated by a dashed line), PDs 642, underfill 660, solder bumps 662, 666, and 668 analogous to fiber array unit 312, cutout 322, PDs 342, underfill 360, solder bumps 362, 366, and 368, respectively.

Photonics package 600 may be a transceiver pluggable package. For example, photonics package may be usable in 400G applications. Photonics package 600 is thus analogous to photonics package 300. However, connection between IC 610 and TFLC PIC 640 (which may be a TFLN transmitter PIC, as indicated in FIGS. 6A-6B), is not made via solder bumps. Instead, TFLC PIC 640 is electrically coupled with IC 610 via high speed RF wire bonds (e.g. ribbon wire bonds) 624. Further, cutout 622 extends under a portion of IC 610. Thus, high speed RF wire bonds 624 may be accommodated. Because high speed RF wire bonds 624 are within air cladding region 650, RF losses of the signals provided to TFLC PIC 640 may be mitigated.

Photonics package 600 may share the benefits of photonics packages 100, 300, 400, and/or 500. For example, photonics package 600 may have reduced RF losses due to air cladding region 650 between interposer 620 and TFLC PIC 640. Electrical connections between IC 610 and TFLC PIC 640 may be shorter. This may allow for improved performance, particularly at higher frequencies, such as 400 G applications. Use of PDs 642 may be facilitated and manufacturing improved. Thus, performance and fabrication of photonics package 600 may be enhanced.

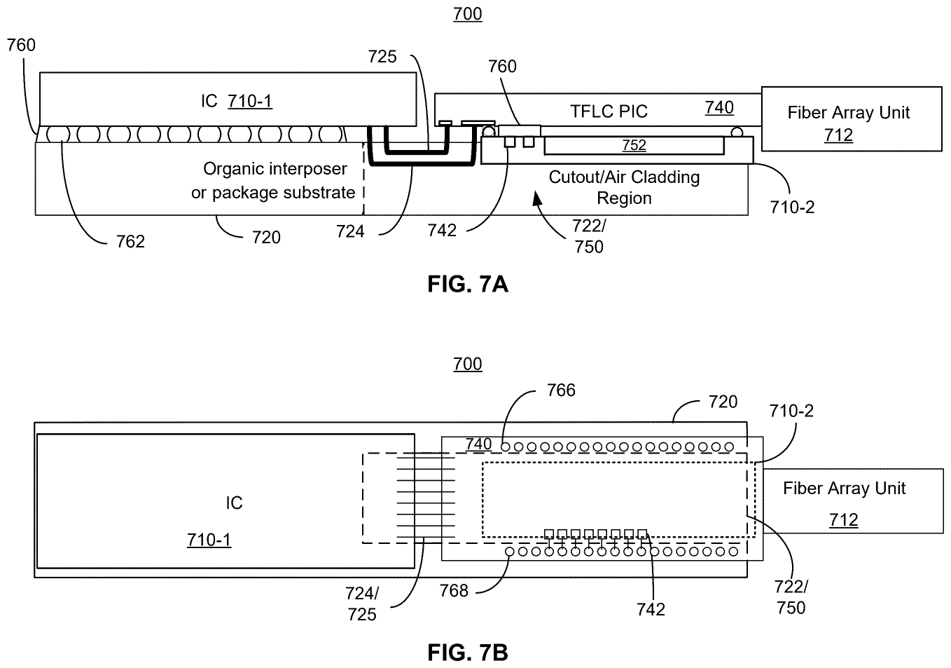

FIGS. 7A-7B depict an embodiment of integrated photonics package 700 including TFLC PIC 740. FIG. 7A depicts a cross-sectional view, while FIG. 7B depicts a top view. Photonics package 700 is analogous to photonics package(s) 100, 300, 400, 500, and 600. Thus, photonics package 700 includes additional IC 710-1, interposer 720, TFLC PIC 740, and air cladding region 750 that are analogous to IC(s) 110 and 610, interposer 120, TFLC PIC 140, and air cladding region 150. Consequently, IC 710-1, interposer 720, TFLC PIC 740, and air cladding region 750 may have an analogous structure and function to IC(s) 110, interposer 120, TFLC PIC 140, and air cladding region 150, respectively. Thus, TFLC PIC 740 may be analogous to TFLC PIC 200 and have some or all of the benefits thereof. Photonics package 700 also includes fiber array unit 712, cutout 722 (indicated by a dashed line), PDs 742, underfill 760, solder bumps 762, 766, and 768 analogous to fiber array unit 312, cutout 322, PDs 342, underfill 360, solder bumps 362, 364, 366, and 368, respectively.

Photonics package 700 may be a transceiver pluggable package. For example, photonics package may be usable in 400G applications. Photonics package 700 is thus analogous to photonics package 600. For example, connection between IC 710-1 and TFLC PIC 740 (which may be a TFLN transmitter PIC, as indicated in FIGS. 7A-7B), is via high speed RF wire bonds (e.g. ribbon wire bonds) 724 and 725. In some embodiments, high speed RF wirebonds 724 are used for transmission of optical signals using photonics package 700, while wirebonds 725 are used for received optical signals. Further, cutout 722 extends under a portion of IC 710-1. Thus, high speed RF wire bonds 724 may be accommodated. Because high speed RF wire bonds 724 are within air cladding region 750, RF losses of the signals provided to TFLC PIC 740 may be mitigated.

In addition, IC 710-2 is provided. IC 710-2 may be a silicon photonics receiver. Because it is located below TFLC PIC 740 (in air cladding region 750), IC 710-2 is shown using a dotted line in FIG. 7B. PDs 742 (of which only one is labeled) may be included in IC 710-2. For example, high speed PDs used in receiving an optical signal and monitor PDs may be included in PDs 742. Further, IC 710-2 includes a cavity 752 therein. Cavity 752 is aligned with at least a portion of the electrodes in TFLC PIC 740. Cavity 752 may thus be considered an additional air cladding region 752. The structure and function of air cladding region 752 are analogous to those of air cladding region 750. Thus, regions of TFLC PIC 740 aligned with the electrodes still adjoin an air cladding region that 750 and/or 752.

Photonics package 700 may share the benefits of photonics packages 100, 300, 400, 500, and/or 600. For example, photonics package 700 may have reduced RF losses due to air cladding region 750 between interposer 720 and TFLC PIC 740 and due to air cladding region 752 between IC 710-2 and TFLC PIC 740. Electrical connections between IC 710 and TFLC PIC 740 may be shorter. This may allow for improved performance, particularly at higher frequencies, such as 400 G applications. Use of PDs 742 may be facilitated and manufacturing improved. Thus, performance and fabrication of photonics package 700 may be enhanced.

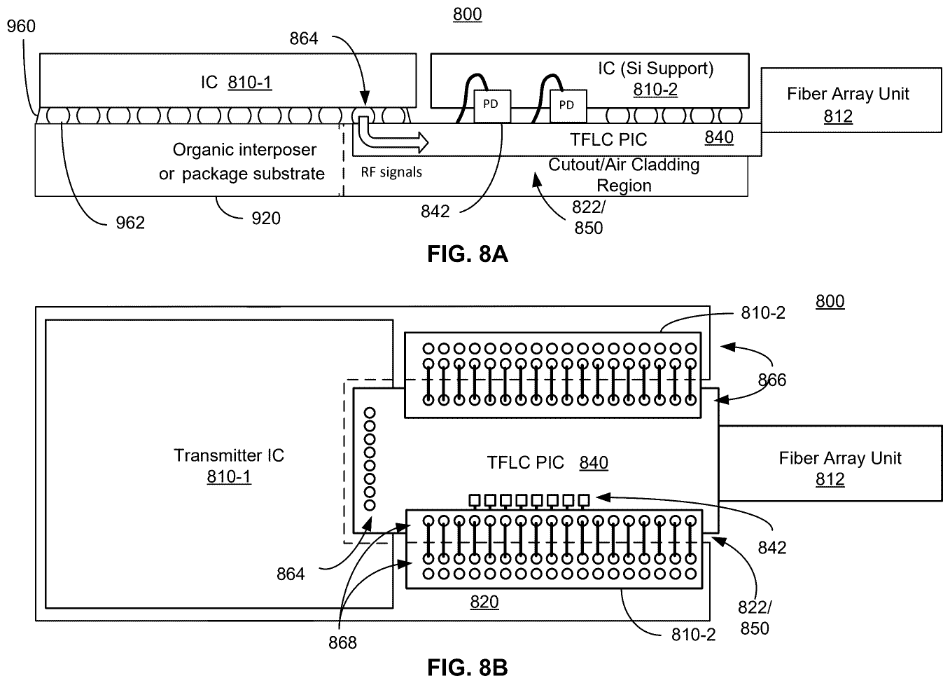

FIGS. 8A-8B depict an embodiment of integrated photonics package 800 including TFLC PIC 840. FIG. 8A depicts a cross-sectional view, while FIG. 8B depicts a top view. Photonics package 800 is analogous to photonics package(s) 100, 300, 400, 500, 600, and 700. Thus, photonics package 800 includes additional IC 810-1, interposer 820, TFLC PIC 840, and air cladding region 850 that are analogous to IC(s) 110 and 610, interposer 120, TFLC PIC 140, and air cladding region 150. Consequently, IC 810-1, interposer 820, TFLC PIC 840, and air cladding region 850 may have an analogous structure and function to IC(s) 110, interposer 120, TFLC PIC 140, and air cladding region 150, respectively. Thus, TFLC PIC 840 may be analogous to TFLC PIC 200 and have some or all of the benefits thereof. Photonics package 800 also includes fiber array unit 812, cutout 822 (indicated by a dashed line), PDs 842, underfill 860, solder bumps 862, 864, 866, and 868 analogous to fiber array unit 312, cutout 322, PDs 342, underfill 360, solder bumps 362, 364, 366, and 368, respectively.

Photonics package 800 may be a transceiver pluggable package. For example, photonics package may be usable in 400G applications. Photonics package 800 is thus analogous to photonics packages 600 and 700. However, connection between IC 810-1 and TFLC PIC 840 (which may be a TFLN transmitter PIC, as indicated in FIGS. 8A-8B), is via solder bumps 864. Further, PDs 842 are shown as mounted on TFLC PIC 840. In some embodiments, some or all PDs 842 may be integrated into ICs 810-2. Cutout 822 extends under a portion of IC 810-1.

In addition, ICs 810-2 may be silicon support structures. ICs 810-2 may provide structural support and serve as an electrical bridge. Thus, electrical connection may be made to interposer 820 via ICs 810-2 (and thus solder bumps 866 and/or 868). In some embodiments, ICs 810-2 are flip-chip attached to interposer 820 near at the “U” shaped portion of interposer 830 proximate to cutout 822. TFLC PIC 840 may be flip-chip attached to ICs 810-2 and electrical connection made via bumps 866 and 868. IC 810-1 (e.g. a digital signal processor and/or other component) may be flip-chip attached to the combination of interposer 820, ICs 810-2, and TFLC PIC 840. Fiber array unit 812 may then be attached.

Photonics package 800 may share the benefits of photonics packages 100, 300, 400, 500, 600, and/or 700. For example, photonics package 800 may have reduced RF losses due to air cladding region 850 proximate to TFLC PIC 840. Electrical connections between ICs 810-1 and 81-2 and TFLC PIC 840 may be shorter. This may allow for improved performance, particularly at higher frequencies, such as 400 G applications. Signal integrity for photonics package 800 may also be improved. Further, TFLC PIC 840 need not be bumped. Instead, solder bumps may be provided on ICs 810-2. Thus, manufacturing may be simplified. Thus, performance and fabrication of photonics package 800 may be enhanced.

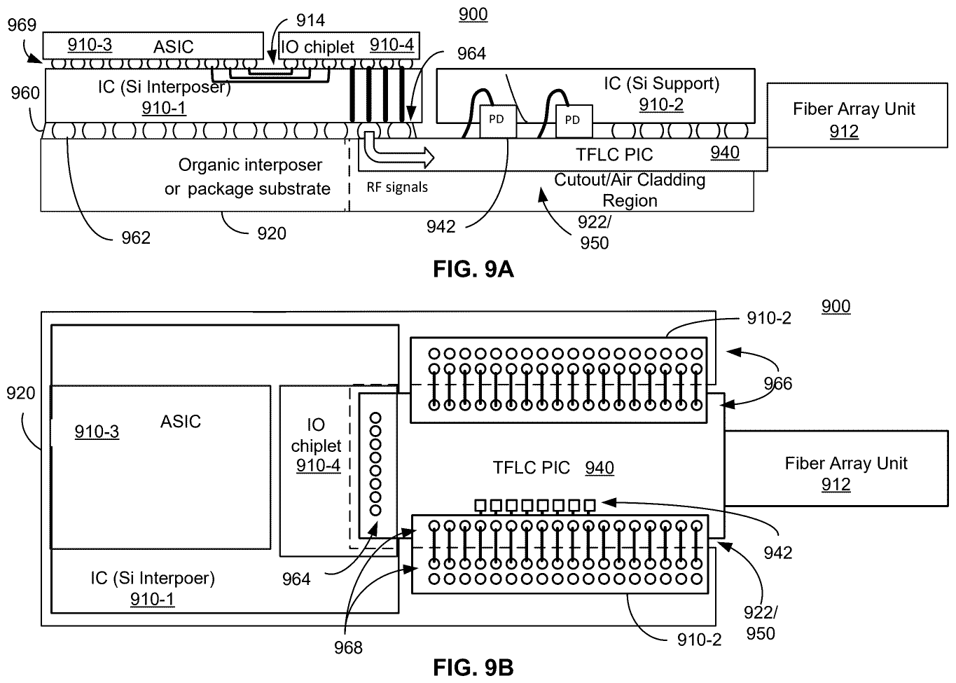

FIGS. 9A-9B depict an embodiment of integrated photonics package 900 including TFLC PIC 940. FIG. 9A depicts a cross-sectional view, while FIG. 9B depicts a top view. Photonics package 900 is analogous to photonics package(s) 100, 300, 400, 500, 600, 700, and 800. Thus, photonics package 900 includes interposer 920, TFLC PIC 940, and air cladding region 950 that are analogous to interposer 120, TFLC PIC 140, and air cladding region 150. Consequently, IC 910-1, interposer 920, TFLC PIC 940, and air cladding region 950 may have an analogous structure and function to IC(s) 110, interposer 120, TFLC PIC 140, and air cladding region 150, respectively. Thus, TFLC PIC 940 may be analogous to TFLC PIC 200 and have some or all of the benefits thereof. Photonics package 900 also includes fiber array unit 912, cutout 922 (indicated by a dashed line), PDs 942, underfill 960, solder bumps 962, 964, 966, and 968 analogous to fiber array unit 312, cutout 322, PDs 342, underfill 360, solder bumps 362, 364, 366, and 358, respectively.

Photonics package 900 may be a computer interconnect package that uses silicon support structures. Photonics package 900 is thus analogous to photonics packages 400 and 500, and 800. Thus, photonics package 900 includes IC 910-1 (interposer 910-1), ICs 910-2, IC 910-3 (ASIC), and input/output IC 910-4 that are analogous to interposer 410-1, ICs (silicon support structures) 810-2, ASIC 410-2, and input/output IC 410-3.

Photonics package 900 may share the benefits of photonics packages 100, 300, 400, 500, 600, 700, and/or 800. For example, photonics package 900 may have reduced RF losses due to air cladding region 950 proximate to TFLC PIC 940. Electrical connections between ICs 910-1 and 91-2 and TFLC PIC 940 may be shorter. Signal integrity for photonics package 900 may also be improved. Further, TFLC PIC 940 need not be bumped. Instead, solder bumps may be provided on ICs 910-2. Thus, manufacturing may be simplified. Thus, performance and fabrication of photonics package 900 may be enhanced.

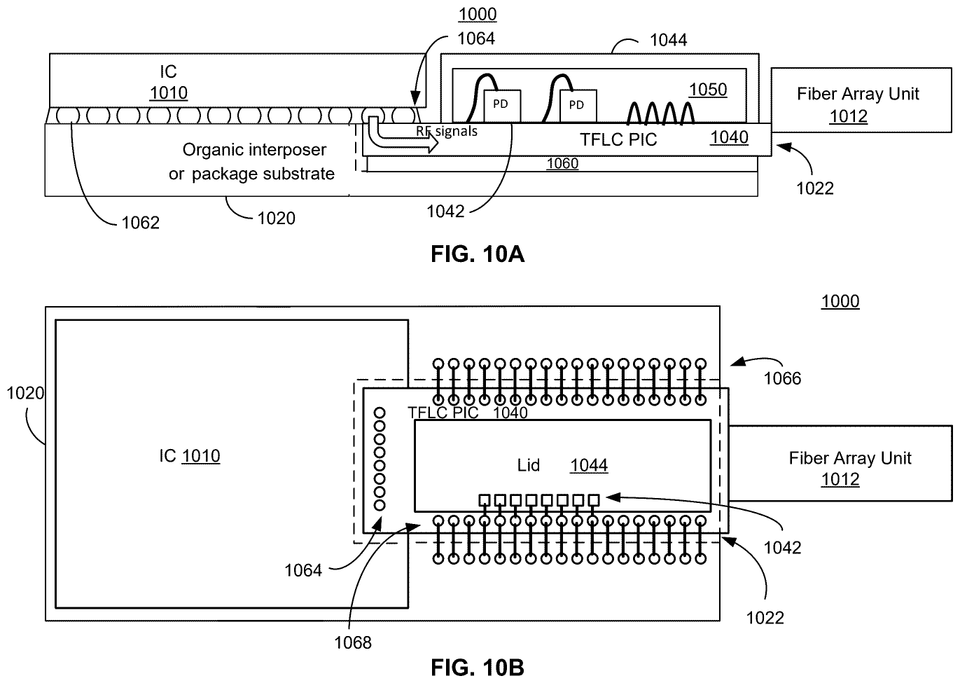

FIGS. 10A-10B depict an embodiment of integrated photonics package 1000 including TFLC PIC 1040. FIG. 10A depicts a cross-sectional view, while FIG. 10B depicts a top view. Photonics package 1000 is analogous to photonics package(s) 100, 300, 400, 500, 600, 700, 800, and 900. Thus, photonics package 1000 includes interposer 1020, TFLC PIC 1040, and air cladding region 1050 that are analogous to interposer 120, TFLC PIC 140, and air cladding region 150. Consequently, IC 1010 (e.g., a transmitter IC), interposer 1020, TFLC PIC 1040, and air cladding region 1050 may have an analogous structure and function to IC(s) 110, interposer 120, TFLC PIC 140, and air cladding region 150, respectively. Thus, TFLC PIC 1040 may be analogous to TFLC PIC 200 and have some or all of the benefits thereof. Photonics package 1000 also includes fiber array unit 1012, cutout 1022 (indicated by a dashed line), PDs 1042, underfill 1060, and solder bumps 1062 and 1064 analogous to fiber array unit 312, cutout 322, PDs 342, underfill 360, solder bumps 362 and 364, respectively. Wire bonds 1066 and 1068 provide connectivity to TFLC PIC 1040. For example, wire bonds 1068 may provide electrical connection to PDs 1042.

Photonics package 1000 may be a transceiver pluggable package. For example, photonics package 1000 may be usable in 400G applications. Photonics package 1000 is thus analogous to photonics packages 600, 700, and 800. In addition, cutout 1022 is configured such that a surface (e.g., the top surface) of TFLC PIC 1040 is substantially flush with a surface (e.g. the top surface) of interposer 1020. In some embodiments, therefore, cutout 1022 is a cavity, or recessed region. TFLC PIC 1040 resides on a portion of interposer 1020. In some embodiments, interposer 1020 may be a monolithic structure. In some embodiments, TFLC PIC 1040 may reside on a shelf that is a separate structure from the remaining portion of interposer 1020. Underfill 1060 may be used to affix TFLC PIC 1040 to interposer 1020. Underfill 1060 may be aligned with electrodes (not shown) of TFLC PIC 1040 because the substrate for TFLC PIC 1040 is between the electrodes and underfill 1060.

TFLC PIC 1040 includes lid 1044. As a result, air cladding region 1050 is formed between lid 1044 and the surface of TFLC PIC 1040. For example, cutout 1022 may be formed and TFLC PIC 1040. This may be accomplished by drilling out or otherwise removing a portion of interposer 1020. TFLC PIC 1040 may be placed upside down and interposer 1020 aligned and placed on TFLC PIC 1040. Underfill 1060 may be applied between interposer 1020 and TFLC PIC 1040. Underfill 1050 fills the region between TFLC PIC 1040 and a surface of interposer 1020 on which TFLC PIC 1040 is to reside. Sufficient underfill 1060 is applied such that the top surface of TFLC PIC 1040 is aligned with the top surface of interposer 1020. Photodetectors may be wire bonded via wires 1068. IC 1010 may be flip-chip attached to interposer 1020 and TFLC PIC 1040.

Photonics package 1000 may share the benefits of photonics packages 100, 300, 400, 500, 600, 800, and/or 900. For example, photonics package 1000 may have reduced RF losses due to air cladding region 1050 proximate to TFLC PIC 1040. Electrical connections between IC 1010 and TFLC PIC 1040 may be shorter. Signal integrity for photonics package 1000 may also be improved. Further, TFLC PIC 1040 need not be bumped. Instead, solder bumps may be provided on ICs 1010-2. Thus, manufacturing may be simplified. Thus, performance and fabrication of photonics package 1000 may be enhanced.

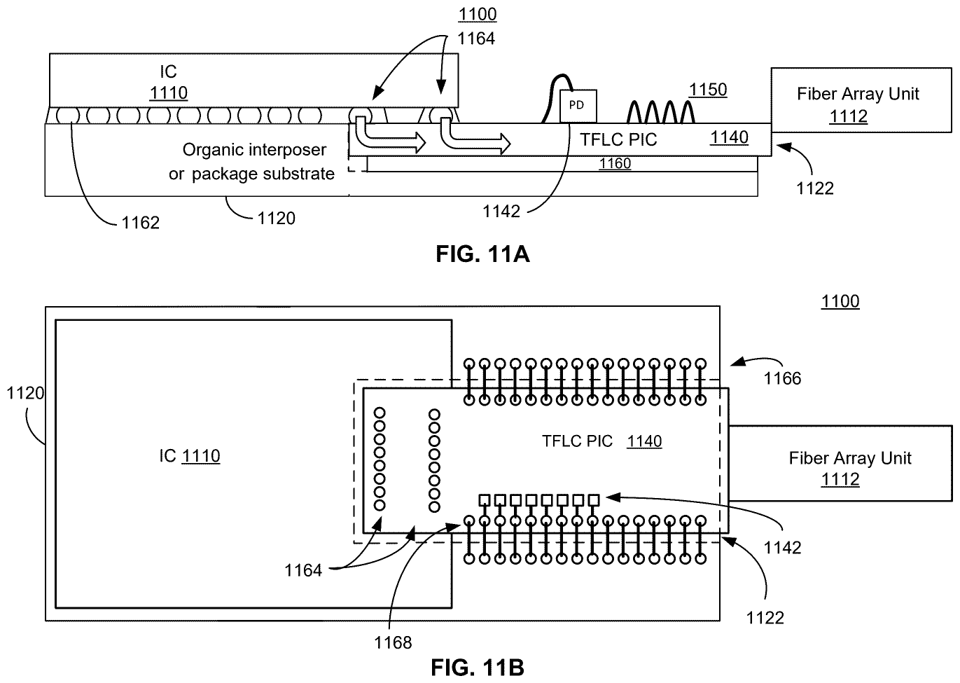

FIGS. 11A-11B depict an embodiment of integrated photonics package 1100 including TFLC PIC 1140. FIG. 11A depicts a cross-sectional view, while FIG. 11B depicts a top view. Photonics package 1100 is analogous to photonics package(s) 100, 300, 400, 500, 600, 700, 800, 900, and 1000. Thus, photonics package 1100 includes IC 1110, interposer 1120, TFLC PIC 1140, and air cladding region 1150 that are analogous to IC(s) 110, interposer 120, TFLC PIC 140, and air cladding region 150. Consequently, IC 1110 (e.g., a transmitter IC), interposer 1120, TFLC PIC 1140, and air cladding region 1150 may have an analogous structure and function to IC(s) 110, interposer 120, TFLC PIC 140, and air cladding region 150, respectively. Thus, TFLC PIC 1140 may be analogous to TFLC PIC 200 and have some or all of the benefits thereof. Photonics package 1100 also includes fiber array unit 1112, cutout 1122 (indicated by a dashed line), PDs 1142, underfill 1160, and solder bumps 1162 and 1164 analogous to fiber array unit 312, cutout 322, PDs 342, underfill 360, solder bumps 362 and 364, respectively. Wire bonds 1166 and 1168 provide connectivity to TFLC PIC 1140. For example, wire bonds 1168 may provide electrical connection to PDs 1142.

Photonics package 1100 may be a transceiver pluggable package. For example, photonics package 1100 may be usable in 400G applications. Photonics package 1100 is thus analogous to photonics packages 600, 700, 800, and 1000. More specifically, photonics package 1100 is analogous to photonic package 1000. Thus, TFLC PIC 1140, interposer 1120, and IC 1110 are analogous to TFLC PIC 1040, interposer 1020, and IC 1010. However, the lid is omitted. In addition, there are two or more columns of bumps between the Transmitter IC and the TFLN PIC1164, to allow for RF signals to drive a grid of modulators. The space between the columns of bumps 1064 may be free of underfill 1160. This may improve RF performance. In some embodiments, a low dielectric constant underfill may be used to mitigate RF losses.

Photonics package 1100 may share the benefits of photonics packages 100, 300, 400, 500, 600, 700, 800, 900, and/or 1000. For example, photonics package 1100 may have reduced RF losses due to air cladding region 1150 proximate to TFLC PIC 1140. Electrical connections between IC 1110 and TFLC PIC 1140 may be shorter. Signal integrity for photonics package 1100 may also be improved. Further, TFLC PIC 1140 need not be bumped. Instead, solder bumps may be provided on ICs 1110-2. Thus, manufacturing may be simplified. Thus, performance and fabrication of photonics package 1100 may be enhanced.

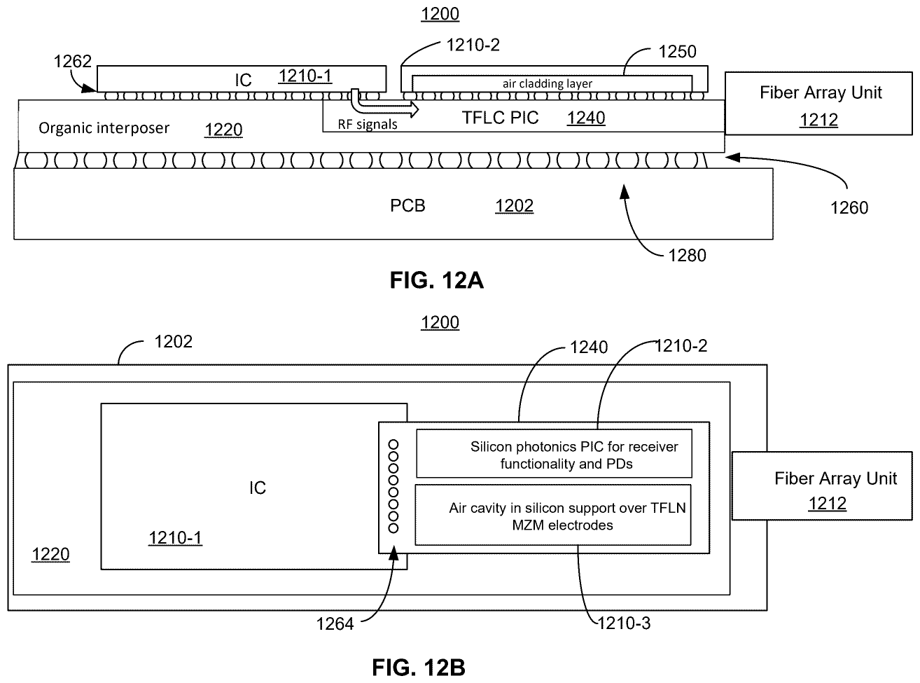

FIGS. 12A-12B depict an embodiment of integrated photonics package 1200 including TFLC PIC 1240. FIG. 12A depicts a cross-sectional view, while FIG. 12B depicts a top view. Photonics package 1200 is analogous to photonics package(s) 100, 300, 400, 500, 600, 700, 800, 900, 1000, and 1100. Thus, photonics package 1200 includes IC 1210-1, interposer 1220, TFLC PIC 1240, and air cladding region 1250 that are analogous to IC(s) 110, interposer 120, TFLC PIC 140, and air cladding region 150. Consequently, IC 1210-1, interposer 1220, TFLC PIC 1240, and air cladding region 1250 may have an analogous structure and function to IC(s) 110, interposer 120, TFLC PIC 140, and air cladding region 150, respectively. Thus, TFLC PIC 1240 may be analogous to TFLC PIC 200 and have some or all of the benefits thereof. Photonics package 1200 also includes fiber array unit 1212, a cutout in which TFLC PIC 1240 resides, and solder bumps 1262 and 1264 analogous to fiber array unit 312, cutout 322, underfill 360, solder bumps 362 and 364, respectively. In addition, printed circuit board (PCB) 1202, solder bumps 1280, IC 1210-2 (silicon support structure), and IC 1210-3 (silicon photonics PIC receiver and PDs) are shown. Photonics package 1200 may function as an embedded bridge. Further, IC 1210-2 includes a cavity forming air cladding region 1250. In addition, IC 1210-2 may hermetically seal the TFLC PIC 1240.

Photonics package 1200 may share the benefits of photonics packages 100, 300, 400, 500, 600, 700, 800, 900, and/or 1000. For example, photonics package 1200 may have reduced RF losses due to air cladding region 1250 proximate to TFLC PIC 1240. Electrical connections between IC 1210 and TFLC PIC 1240 may be shorter. Signal integrity for photonics package 1200 may also be improved. Further, TFLC PIC 1240 need not be bumped. Instead, solder bumps may be provided on ICs 1210-2. Thus, manufacturing may be simplified. Thus, performance and fabrication of photonics package 1200 may be enhanced.

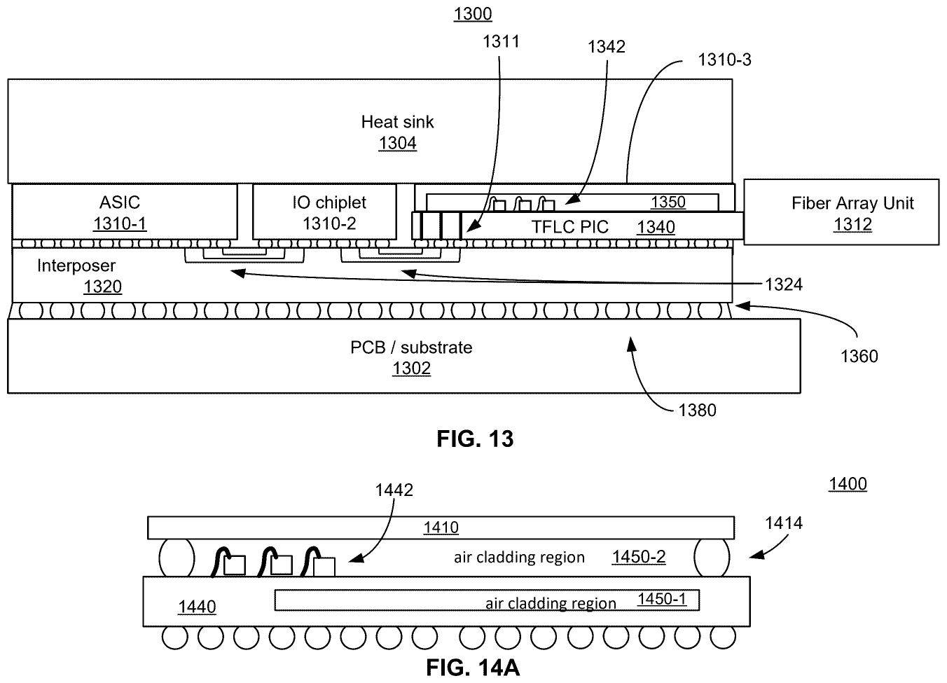

FIG. 13 depicts a cross-sectional view of an embodiment of integrated photonics package 1300 including TFLC PIC 1340. Photonics package 1300 is analogous to photonics package(s) 100, 300, 400, 500, 600, 700, 800, 900, 1000, 1100, and 1200. Thus, photonics package 1300 includes ICs 1310-1 and 1310-2, interposer 1320, TFLC PIC 1340, and air cladding region 1350 that are analogous to IC(s) 110, interposer 130, TFLC PIC 140, and air cladding region 150. Consequently, ICs 1310-1 (e.g., an ASIC) and 1310-2 (e.g., a chiplet), interposer 1320, TFLC PIC 1340, and air cladding region 1350 may have an analogous structure and function to IC(s) 110, interposer 120, TFLC PIC 140, and air cladding region 150, respectively. Thus, TFLC PIC 1340 may be analogous to TFLC PIC 200 and have some or all of the benefits thereof. Photonics package 1300 also includes fiber array unit 1312, PDs 1342, underfill 1360, interconnects 1324 (e.g. RDL(s)), and solder bumps analogous to fiber array unit 312, PDs 342, underfill 360, interconnects 324, and solder bumps 362, 364, 366, and 368, respectively. Photonics package 1300 also includes PCB 1302, solder bumps 1380, and IC 1310-3 that are analogous to PCB 1202, solder bumps 1280, and IC 1210-2 (silicon support structure). Heat sink 1304 may also be included.

Photonics package 1300 may be a multi-chip module. Thus, multiple components of various functionality may be included. Various integration techniques may also be used. For example, TSVs 1311 may be used in some embodiments. Further, IC 1310-3 includes a cavity forming air cladding region 1350. IC 1310-3 may hermetically seal the TFLC PIC 1340.

Photonics package 1300 may share the benefits of photonics packages 100, 300, 400, 500, 600, 700, 800, 900, 1000, 1100, and/or 1200. For example, photonics package 1300 may have reduced RF losses due to air cladding region 1350 proximate to TFLC PIC 1340. Electrical connections between ICs 1310-1 and 1310-2 and TFLC PIC 1340 may be shorter. Signal integrity for photonics package 1300 may also be improved. Thus, performance and fabrication of photonics package 1300 may be enhanced.

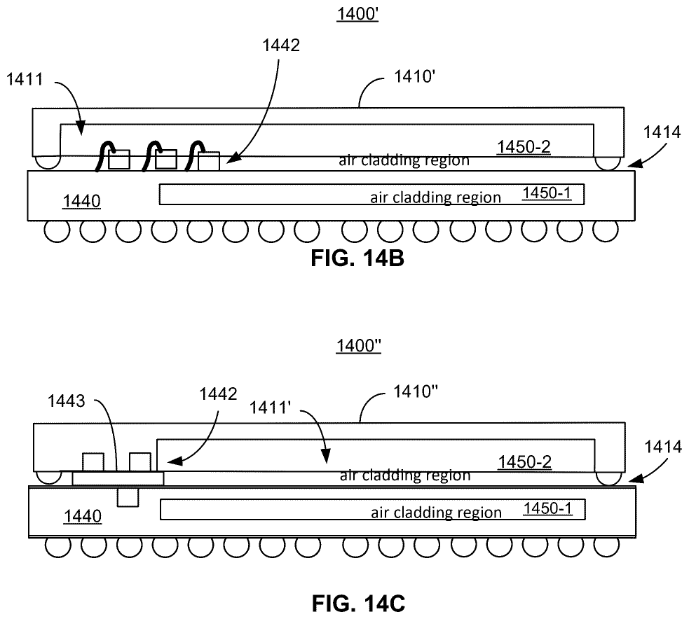

FIGS. 14A, 14B, and 14C depict embodiments of TFLC devices 1400, 1400′, and 1400″ usable in a photonics package, such as package(s) 100, 300, 400, 500, 600, 700, 800, 900, 1000, 1100, 1200, 1300, 1500, 1600, 1700, and/or 1800. TFLC devices 1400, 1400′, and/or 1400″ may each be used as or included in TFLC PICs such as TFLC PICs 140, 200, 340, 440, 540, 640, 740, 840, 940, 1040, 1140, 1240, and/or 1340. Referring to FIG. 14A, TFLC device 1400 includes TFLC PIC 1440, PDs 1424, and silicon support structure 1410 analogous to TFLC PIC 200, PDs 324, and silicon support structure 1210-2 and 1310-3. However, TFLC PIC 1440 includes air cladding region 1450-1 therein. Air cladding region 1450-1 may be provided by forming voids within the substrate (or other structures) of TFLC PIC 1440. For example, air cladding region 1450-1 may be formed during the front end of line fabrication processes. For example, deep holes may be etched around the waveguide and electrodes of TFLC PIC 1440. The etching may be from the top surface of the chip to the bottom silicon substrate. Selective, isotropic etching of the silicon material (e.g., an XeF₂ etch) may be used. This may suspend the optical waveguides and electrodes allowing for better RF performance.

In addition to air cladding region 1450-1, silicon support structure 1410 may be used to provide air cladding region 1450-2. Air cladding regions 1450-1 and 1450-2 function and include components in an analogous manner to air cladding regions 150. Silicon support structure 1410 may be considered to form a lid for TFLC PIC 1440. Lid 1410 may protect the surface of the TFLIC PIC 1440 from pick and place tools (and/or damage from other processes). Lid 1410 may include or be a metal ground plate to improve device performance.

In some embodiments, lid 1410 may be formed by using solder bumps, or a solder “frame” 1414 to hermetically seal the air, vacuum, or other gas(es) above the TFLC PIC 1440 (i.e. between the solder frame 1414, TFLC PIC 1440, and silicon support structure 1410. In some embodiments, lid 1410 is not airtight. The metal “frame” may be removed in some areas, so that the RF waveguide does not travel under the metal (which could increase loss). For example, in the embodiments where there is no TSV on the TFLC PIC 1400, there may be pads for the RF signal to enter the TFLC PIC 1440. The pads may not have the lid on top of them. Thus, lid 1410 may cover only a portion of TFLC PIC 1440. The modulator electrode under lid 1410 and the pads are to be connected, and having the large metal chip frame above the connection may negatively impact the signal integrity.

Other techniques for forming a lid may be used. For example, FIG. 14B depicts TFLC device 1400′ in which top lid 1410′ has cavity 1411 etched into it. Cavity 1411 may provide additional vertical clearance for monitor PDs 1442 or a larger air cladding region 1450-2 above the TFLC PIC 1440. In various embodiments, the top lid 1410′ allows for clearance between the lid and chip of greater than 400 microns, 300-400 microns, or less than 300 microns. The amount of clearance between lid 1410/1410′ and the electrodes within TFLC PIC 1440 may be designed to prevent RF interference. FIG. 14C depicts an embodiment of TFLC device 1400″ in which monitor photodiodes 1442 are built into lid 1410″ (as opposed to within air cladding region 1450-2 and/or cavity 1411). Thus, cavity 1411′ may extend over a smaller region of TFLC PIC 1440. In such embodiments, index matching material 1443may be used to affix lid 1410 to TFLC PIC 1440 in the region of PDs 1442. In some embodiments, lid 1410 may be an entire silicon photonics chip with high-speed photodetectors. Lid 1410 may have through silicon vias (TSVs) therein. For example, if flip-chip bonding is used for both the TFLC PIC 1440 and lid 1410.

Thus, using photonics device 1400, performance may be further improved. Additional air cladding region 1450-1 may further reduce microwave (RF) losses. Use of lid 1410 may not only improve performance, but also enhance robustness of photonics device 1400. Thus, performance may be improved.

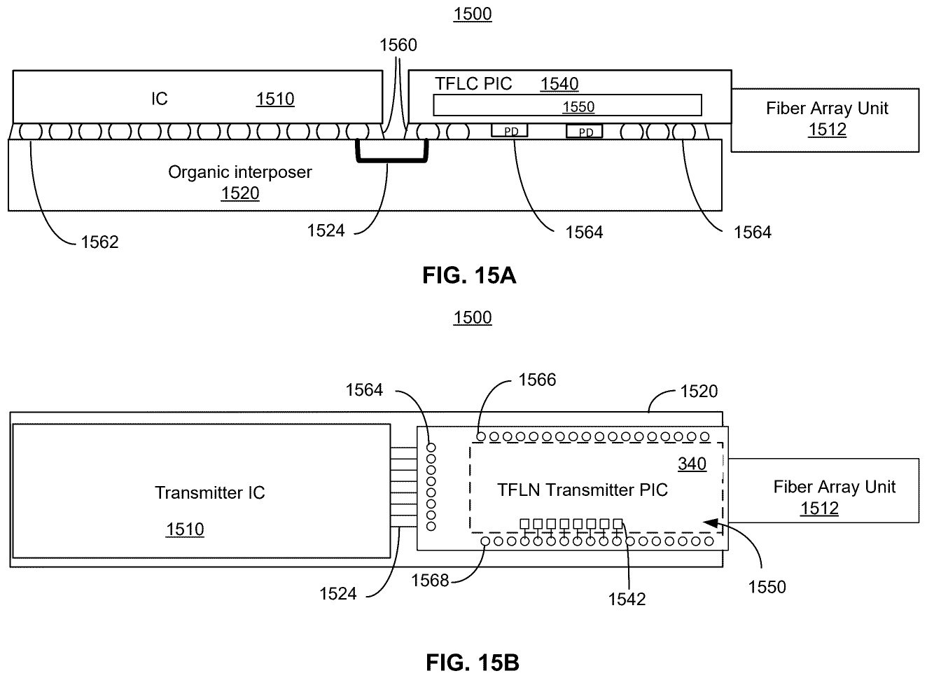

FIGS. 15A-15B depict an embodiment of integrated photonics package 1500 including TFLC PIC 1540. FIG. 15A depicts a cross-sectional view, while FIG. 15B depicts a top view. Photonics package 1500 is analogous to photonics package(s) 100, 300, 400, 500, 600, 700, 800, 900, 1000, 1100, 1200, and 1300. Thus, photonics package 1500 includes IC 1510, interposer 1520, TFLC PIC 1540, and air cladding region 1550 that are analogous to IC 110, interposer 120, TFLC PIC 140, and air cladding region 150. Consequently, IC 1510 (e.g., a transmitter IC), interposer 1520, TFLC PIC 1540, and air cladding region 1550 may have an analogous structure and function to IC(s) 110, interposer 120, TFLC PIC 140, and air cladding region 150, respectively. Thus, TFLC PIC 1540 may be analogous to TFLC PIC 200 and have some or all of the benefits thereof. Photonics package 1500 also includes fiber array unit 1512, PDs 1542, underfill 1560, interconnects 1524, and solder bumps 1562, 1564, 1566, and 1568 analogous to fiber array unit 312, cutout 322, PDs 342, underfill 360, interconnects 324, solder bumps 362, 364, 366, and 368, respectively. Photonics package 1500 may be a transceiver pluggable package. In addition, for air cladding region 1550 is provided within TFLC PIC 1540.

Photonics package 1500 may share the benefits of photonics packages 100, 300, 400, 500, 600, 700, 800, 900, 1000, 1100, 1200, and/or 1300. For example, photonics package 1500 may have reduced RF losses due to air cladding region 1550 proximate to TFLC PIC 1540. Electrical connections between IC 1510 and TFLC PIC 1540 may be shorter. Thus, performance and fabrication of photonics package 1500 may be enhanced.

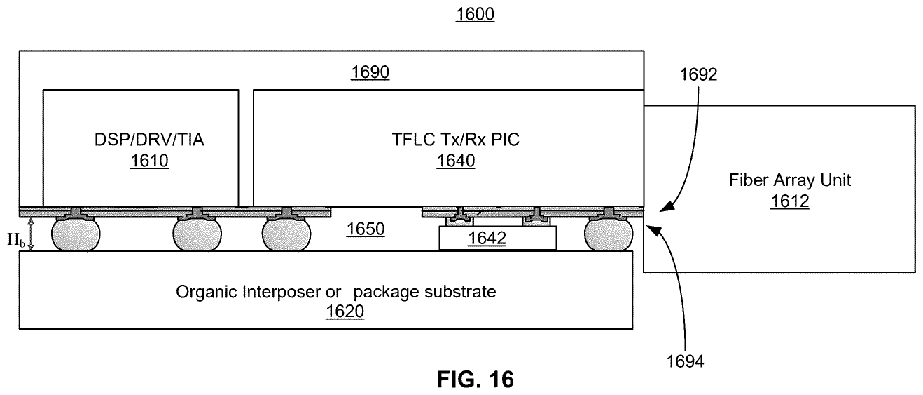

FIG. 16 depicts a cross-sectional view of an embodiment of integrated photonics package 1600 including TFLC PIC 1640. Photonics package 1600 is analogous to photonics package(s) 100, 300, 400, 500, 600, 700, 800, 900, 1000, 1100, 1200, 1300, and 1500. Thus, photonics package 1600 includes IC 1610, interposer 1620, TFLC PIC 1640, and air cladding region 1650 that are analogous to IC 110, interposer 120, TFLC PIC 140, and air cladding region 150. Consequently, IC 1610, interposer 1620, TFLC PIC 1640, and air cladding region 1650 may have an analogous structure and function to IC(s) 110, interposer 120, TFLC PIC 140, and air cladding region 150, respectively. Thus, TFLC PIC 1640 may be analogous to TFLC PIC 200 and have some or all of the benefits thereof. Photonics package 1600 also includes fiber array unit 1612, PD 1642, and solder bumps 1694 analogous to fiber array unit 312, cutout 322, PDs 342, underfill 360, interconnects 324, solder bumps 362, 364, 366, and 368, respectively. Also shown is under bump metal 1692. Also shown is mold 1690.

Photonics package 1600 may be a multi-chip package with fan-out panel level packaging. Mold 1690 is diced to create an optical facet for input coupling. Thus, FIG. 16 may be considered to depict device 1600 during fabrication. High speed RF pads on TFLC PIC 1640 are connected to IC 1610 (e.g., DSP/DRV/TIA ICs) via RDL in interposer 1620. This allows for high bandwidth RF performance and may obviate the need for TSVs. Monitor PD 1642 is flip chip bonded onto TFLC PIC 1640 first. This may be accomplished using a chip-on-chip (possum) process. Photo sensitive polyimide may be used such that the RDL layer on top of the modulation region of TFLC PIC 1640 may be removed. Alternatively, lithography and etching of the RDL layer may be done after under bump metal 1692 is formed and before bumping (adding the solder ball bonds 1694). In some embodiments, under bump metal 1692 may be etched away in the region aligned with electrodes (and optionally other and/or different regions) in TFLC 1640. In some embodiments, the polyimide is not photosensitive and is etched away by other means. If the ball bond height Hb is greater than 500 micrometers, no carving may be done on the organic interposer 1620. Stated differently, cutouts may be avoided while maintaining air cladding region 1650. No under fill may be used to bond the ball bonds to the organic interposer 1640. The circumference of the ball bonds 1694 to organic interposer 1620 may or may not be sealed with under fill.

Photonics package 1600 may share the benefits of photonics packages 100, 300, 400, 500, 600, 700, 800, 900, 1000, 1100, 1200, 1300, and/or 1500. For example, photonics package 1600 may have reduced RF losses due to air cladding region 1650 proximate to TFLC PIC 1640. Electrical connections between IC 1610 and TFLC PIC 1640 may be shorter. Thus, performance and fabrication of photonics package 1600 may be enhanced.

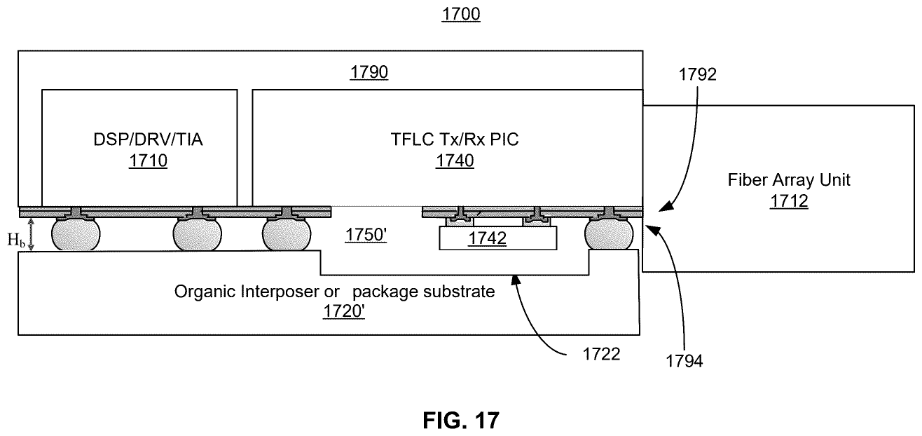

FIG. 17 depicts a cross-sectional view of an embodiment of integrated photonics package 1700 including TFLC PIC 1740. Photonics package 1700 is analogous to photonics package(s) 100, 300, 400, 500, 600, 700, 800, 900, 1000, 1100, 1200, 1300, 1500, and 1600. Thus, photonics package 1700 includes IC 1710, interposer 1720, TFLC PIC 1740, and air cladding region 1750 that are analogous to IC 110, interposer 120, TFLC PIC 140, and air cladding region 150. Consequently, IC 1710, interposer 1720, TFLC PIC 1740, and air cladding region 1750 may have an analogous structure and function to IC(s) 110, interposer 120, TFLC PIC 140, and air cladding region 150, respectively. Thus, TFLC PIC 1740 may be analogous to TFLC PIC 200 and have some or all of the benefits thereof. Photonics package 1700 also includes fiber array unit 1712, PD 1742, and solder bumps 1794 analogous to fiber array unit 312, PDs 342, underfill 360, interconnects 324, solder bumps 362, 364, 366, and 368, respectively. Also shown is under bump metal 1792. Also shown is mold 1790.

Photonics package 1700 may be a multi-chip package with fan-out panel level packaging. Thus, photonics package 1700 may be most analogous to multi-chip package 1600. Components of photonics package 1700 that appear analogous to components of photonics package are labeled similarly. Thus, phonics package 1700 includes IC 1710, fiber array unit 1712, interposer 1720′, TFLC PIC 1740, PD 1742, air cladding region 1750′, metallization 1792, and solder bumps 1795 that are analogous to IC 1610, fiber array unit 1612, interposer 1620, TFLC PIC 1640, PD 1642, air cladding region 1650, metallization 1692, and solder bumps 1695.

In photonics package 1700, the ball height, Hb is less than 500 micrometers. Consequently, cavity, or cutout 1722 is formed in interposer 1720′. Cutout 1722 may be analogous to cutout 322. Consequently, air cladding region 1750′ is larger (i.e. taller) than air cladding region 1650. Thus, PD 1742 may be accommodated. Further RF losses may be mitigated.

Photonics package 1700 may share the benefits of photonics packages 100, 300, 400, 500, 600, 700, 800, 900, 1000, 1100, 1200, 1300, 1500, and/or 1600. For example, photonics package 1700 may have reduced RF losses due to air cladding region 1750 proximate to TFLC PIC 1740. Electrical connections between IC 1710 and TFLC PIC 1740 may be shorter. Thus, performance and fabrication of photonics package 1700 may be enhanced.

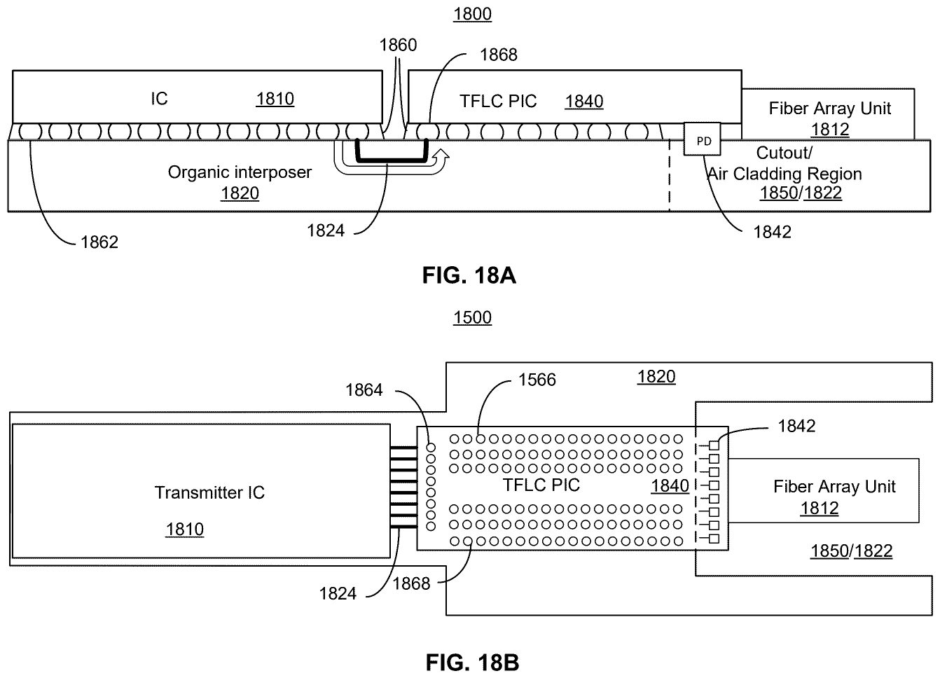

FIGS. 18A-18B depict an embodiment of integrated photonics package 1800 including TFLC PIC 1840. FIG. 18A depicts a cross-sectional view, while FIG. 18B depicts a top view. Photonics package 1800 is analogous to photonics package(s) 100, 300, 400, 500, 600, 700, 800, 900, 1000, 1100, 1200, 1300, 1500, 1600, and 1700. Thus, photonics package 1800 includes IC 1810 (which may be a transmitter IC), interposer 1820, TFLC PIC 1840 (which may include a transmitter PIC), and air cladding region 1850 that are analogous to IC 110, interposer 120, TFLC PIC 140, and air cladding region 150. Consequently, IC 1810, interposer 1820, TFLC PIC 1840, and air cladding region 1850 may have an analogous structure and function to IC(s) 110, interposer 120, TFLC PIC 140, and air cladding region 150, respectively. Thus, TFLC PIC 1840 may be analogous to TFLC PIC 200 and have some or all of the benefits thereof. Photonics package 1800 also includes fiber array unit 1812, cutout 1822, PD 1842, and solder bumps 1864, 1866, and 1868 analogous to fiber array unit 312, cutout 322, PDs 342, underfill 360, interconnects 324, solder bumps 362, 364, 366, and 368, respectively.

In photonics package 1800, PDs 1842 are provided over cutout 1822. Further, PDs 1842 are placed close to the fiber attach edge (e.g., the edge of TFLC PIC coupled to fiber array unit 1812). Thus, PDs 1842 overhang cutout 1822/air cladding region 1850. This configuration allows the amount of TFLC PIC 1840 overhanging cutout 1822 to be optimized while achieving the desired performance.

Photonics package 1800 may share the benefits of photonics packages 100, 300, 400, 500, 600, 700, 800, 900, 1000, 1100, 1200, 1300, 1500, 1600, and/or 1700. For example, photonics package 1800 may have reduced RF losses due to air cladding region 1850 proximate to TFLC PIC 1840. Electrical connections between IC 1810 and TFLC PIC 1840 may be shorter. Thus, performance and fabrication of photonics package 1800 may be enhanced.

Thus, TFLC photonic devices 100, 200, 300, 400, 500, 600, 700, 800, 900. 1000, 1100, 1200, 1300, 1400, 1400′, 1400″, 1500, 1600, 1700, and/or 1800 may provide for high frequency/high bandwidth communications, such as 400G/lane datacenter links. In some embodiments a pristine, ultra short electrical channel between the ICs used (e.g., DSP or ASIC drivers) and the TFLC PIC is achieved through RDLs in the interposers. The embodiments of the packaging described herein may allow a TFLC PIC to be used in a 400G communication. In some embodiments, cutouts in an interposer that may prevent underfill from covering the TFLN chip, provide air cladding region(s), and allow for monitor PDs placed on the chip to not collide with the interposer. Some embodiments use cutout(s) in an interposer to place a particular surface the TFLN PIC at flush with (e.g. within tolerances of the same level as) a surface of interposer. Consequently, a direct attach of the TFLN PIC to the IC bumps may be achieved. This approach may reduce or minimize the distance between the electrical IC and the TFLC PIC. Existing techniques for photonics integration into a 2.5D package use an overhang from an interposer or cutouts only for providing clearance for doing fiber attach at the edge of the chip. In contrast, the techniques and systems described herein utilize large cutouts that are approximately the size of the TFLN PIC. Thus, a large area of the photonics chip may be air clad (at least the region proximate to the RF electrodes and in some embodiments a larger region). Moreover, mechanical stability of the TFLN PIC may be improved. A top lid may be provided. The top lid may provide space for air cladding. In some embodiments, the top lid hermetically seals the surface of the PIC while keeping the top surface of the PIC air clad. This may facilitate the TFLN PIC being integrated into advanced semiconductor packaging processes. This type of packaging has not been tried before in TFLN PICs (or other lithium-containing PICs). TFLN PICs are a new technology usable for exceptionally high bandwidths. However, careful design of the RF mode and how the RF mode interacts with the packaging are desired. The air cladding, cutouts, and other features of the packaging described herein facilitate the use of TFLN PICs for such applications.

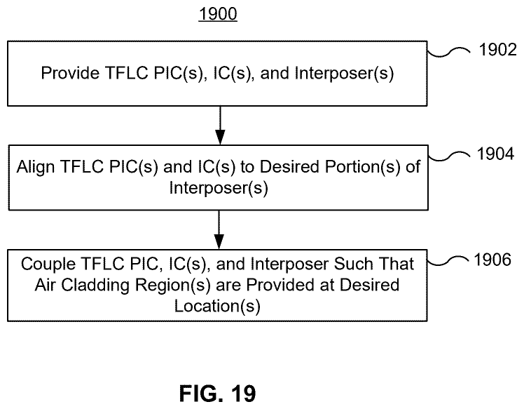

FIG. 19 is a flow-chart depicting an embodiment of method 1900 for providing a photonics package including a TFLC PIC. Method 1900 is described in the context of processes that may have sub-processes. Although described in a particular order, another order not inconsistent with the description herein may be utilized. For example, in some embodiments, portions of processes may be interleaved. Method 1900 is also described in the context of photonics package 100. However, method 800 may be used with other electro-optic devices including but not limited to photonics packages 300, 400, 500, 600, 700, 800, 900, 1000, 1100, 1200, 1300, 1500, 1600, 1700, and/or 1800 and TFLC photonics PICs 200, 1400, 1400′ and/or 1400″.

The components desired to be integrated are provided, at 1902. Thus, the TFLC PIC(s), IC(s), and interposer(s) to be used are provided. In some embodiments, 1902 includes manufacturing one or more of these components. In some embodiments, the components may be built to specifications or otherwise obtained.

The TFLC PIC(s) and IC(s) are aligned to the desired portions of one or more interposers, at 1904. The TFLC PIC(s) and IC(s) are coupled with the interposer(s), at 1906. The TFLC PIC(s), IC(s), and/or interposer(s) are configured such that air cladding region(s) are proximate to the portion of the TFLC PIC(s) near (e.g. aligned with) the electrode(s) of TFLC PIC(s). For example, The TFLC PIC(s), interposer(s), and/or IC(s) are configured such that a portion of the TFLC PIC aligned with the electrode is separated from another component by an air cladding region. In some embodiments, the air cladding region(s) are provided at 1906 because of the configuration of the TFLC PIC(s), interposer(s), and/or IC(s) provided at 1902. For example, cutout(s) in the interposer(s), lid(s) for the TFLC PIC(s), air cladding region(s) and/or (e.g., void(s)) within the TFLC PIC(s) may be formed as part of 1902. At 1904 the components are aligned such that the configurations of the components may result in the formation of air cladding region(s). At 1906, the appropriate type of bonding may be carried out. For example, the TFLC PIC(s) may be flip-chip attached to the desired portion of the interposer and/or the IC(s) may be attached (flip-chip or otherwise) to the TFLC PIC(s) and/or interposer(s). Thus, the desired integrated photonic package may be manufactured.

For example, photonics package 100 may be formed using method 1900. IC(s) 110, TFLC PIC 140, and interposer 120 are provided, at 1902. TFLC PIC 140 and IC(s) 110 are aligned to the appropriate portion of interposer 120 and attached, at 1904 and 1906. In some embodiments, the alignment and attachment processes are carried out first for TFLC PIC 140, then for IC(s) 110. Alternatively, one or more of IC(s) 110 may be aligned and attached to interposer 120 before TFLC PIC 140. The components 110, 120, and 140 are configured and alignment and attachment of 1904 and 1906 are carried out such that air cladding region 150 is provided. Thus, TFLC photonics package 100 may be provided and the attendant benefits realized.

In another example, photonics package 300 may be formed. At 1902, IC 310, TFLC PIC 340, and interposer 320 are provided. 1902 may include forming cutout 322. In some embodiments, 1902 includes wire bonding PDs 342 to TFLC PIC 340. At 1904, IC 310 and TFLC PIC 340 are aligned to the appropriate portions of interposer 320. For example, contacts in IC 310 and TFLC PIC 340 are aligned with the appropriate solder bumps 362, 364, 366, and/or 368. At 1906, TFLC PIC 340 and IC 310 are affixed to interposer 320. For example, IC 310 may be aligned and affixed to interposer 320 (e.g. via flip-chip bonding) at 1904 and 1906. TFLC PIC 340 may then be aligned with and affixed to interposer 320 (e.g. via flip-chip bonding). In some embodiments, PDs 342 may be affixed to TFLC PIC 340 at 1906 after TFLC PIC 340 has been attached to interposer 320. In some embodiments, affixing PDs 342 is facilitated by cutout 322 extending through the entire thickness of interposer 320. Method 1900 may be used in providing photonics packages, such as packages 100, 300, 400, 500, 600, 700, 800, 900, 1000, 1100, 1200, 1300, 1500, 1600, and/or 1700. Thus, the benefits of the devices described herein may be achieved.

Although the foregoing embodiments have been described in some detail for purposes of clarity of understanding, the invention is not limited to the details provided. There are many alternative ways of implementing the invention. The disclosed embodiments are illustrative and not restrictive.

1. A photonics package, comprising:
a thin film lithium-containing (TFLC) photonics integrated circuit (PIC), the TFLC PIC including an electrode and a TFLC optical component, the TFLC component including at least one TFLC electro-optic material;
an additional integrated circuit (IC); and
an interposer coupled with the TFLC PIC and the additional IC;
wherein at least one of the TFLC PIC or the interposer is configured such that a portion of the TFLC PIC is separated from an other component by an air cladding region.

2. The photonics package of claim 1, wherein the portion of the TFLC PIC separated from the other component by the air cladding region is aligned with the electrode.

3. The photonics package of claim 2, wherein the air cladding region includes at least one of air, vacuum, a gas, or a non-reactive gas, the non-reactive gas being nonreactive with respect to the portion of the TFLC PIC aligned with the electrode.

4. The photonics package of claim 2 wherein the air cladding region has a thickness of at least fifty micrometers and not more than one thousand micrometers.

5. The photonics package of claim 4, wherein the thickness of the air cladding region is at least one hundred micrometers and not more than six hundred micrometers.

6. The photonics package of claim 2, wherein the electrode is aligned with a portion of the interposer and wherein the interposer further includes:
a cutout region including the portion of the interposer aligned with the electrode.

7. The photonics package of claim 6, wherein the interposer has a first surface and wherein the TFLC PIC is coupled with the interposer such that a surface of the TFLC PIC is aligned with the first surface.

8. The photonics package of claim 2, wherein the TFLC PIC includes a lid, the air cladding region residing between the portion of the TFLC PIC aligned with the electrode and a surface of the lid.

9. The photonics package of claim 2, wherein the electrode is aligned with a portion of the interposer; and
wherein the TFLC PIC is embedded in the interposer such that the air cladding region separates the portion of the interposer from the TFLC PIC.

10. The photonics package of claim 2, wherein the TFLC PIC is flip-chip coupled with the interposer.

11. A thin film lithium-containing (TFLC) photonics integrated circuit (PIC) comprising:
an electrode; and
a TFLC optical component, the TFLC component including at least one TFLC electro-optic material,
wherein the TFLC PIC is integrated in a photonics package with an additional integrated circuit (IC) and an interposer coupled with the TFLC PIC and the additional IC, at least one of the TFLC PIC or the interposer being configured such that a portion of the TFLC PIC is separated from an other component by an air cladding region.

12. The TFLC PIC of claim 11, wherein the portion of the TFLC PIC separated from the other component by the air cladding region is aligned with the electrode.

13. The TFLC PIC of claim 12, wherein the air cladding region includes at least one of air, vacuum, a gas, or a non-reactive gas, the non-reactive gas being nonreactive with respect to the portion of the TFLC PIC aligned with the electrode.

14. The TFLC PIC of claim 12, wherein the air cladding region has a thickness of at least fifty micrometers and not more than one thousand micrometers.

15. The TFLC PIC of claim 12, wherein the electrode is aligned with a portion of the interposer and wherein the interposer further includes:
a cutout region including the portion of the interposer aligned with the electrode.

16. The TFLC PIC of claim 15, wherein the interposer has a first surface and wherein the TFLC PIC is coupled with the interposer such that a surface of the TFLC PIC is aligned with the first surface.

17. The TFLC PIC of claim 12, further comprising:
a lid, the air cladding region residing between the portion of the TFLC PIC aligned with the electrode and a surface of the lid.

18. The TFLC PIC of claim 12, wherein the electrode is aligned with a portion of the interposer and wherein the TFLC PIC is embedded in the interposer such that the air cladding region separates the portion of the interposer from the TFLC PIC.

19. A method, comprising:
coupling a thin film lithium-containing (TFLC) photonics integrated circuit (PIC) with an interposer and an additional integrated circuit (IC), the TFLC PIC including an electrode and a TFLC optical component, the TFLC component including at least one TFLC electro-optic material;
wherein at least one of the TFLC PIC or the interposer is configured such that a portion of the TFLC PIC is separated from an other component by an air cladding region.

20. The method of claim 19, wherein the portion of the TFLC PIC separated from the other component by the air cladding region is aligned with the electrode.
